(19) United States
(12) Patent Application Publication
(10) Pub. No.: US 2022/0334048 A1
(43) Pub. Date: Oct. 20, 2022

(54) Techniques for forecasting and/or preventing degradation and corrosion

(71) Applicant: AMS Trace Metals, Inc., Sunnyvale, CA (US)

(72) Inventors: Vladimir Dozortsev, Ridgewood, NJ (US); Richard Bacon, Fremont, CA (US); David Johnston, Sunnyvale, CA (US)

(21) Appl. No.: 17/624,900

(22) PCT Filed: Sep. 14, 2020
(86) PCT No.: PCT/US20/50773

§ 371 Date: Jan. 5, 2022

Related U.S. Application Data
(60) Provisional application No. 62/903,617, filed on Sep. 20, 2019.

(51) Int. Cl. G01N 17/00; C02F 1/00; G05B 13/02

(52) U.S. Cl. CPC G01N 17/006; C02F 1/008; G05B 13/0265; C02F 2103/023

(57) ABSTRACT

This disclosure provides techniques for detecting and/or inhibiting corrosion of a distribution/recirculation network for a fluid, e.g., an aqueous matrix (liquid). For example, the disclosed techniques can be used to measure and/or predict degeneration of pipes, solder joints and various other plumbing fixtures in a water distribution network or heat transfer recirculation network caused as a function of variation in environmental parameters. In one embodiment, a system builds a database by measuring metal corrosion (e.g., from lead or copper pipe, solder joint or other type of plumbing vessel or fixture) and correlating degradation of a layer of protective scale and/or metal concentrations present with measured environmental parameters; later, as conditions vary, the database (or associated correlation weights/values) may be used to predict degradation of scale health and/or corrosion stemming from short and/or long term water conditions, and to effectuate advance mitigation.

This disclosure claims priority to U.S. Provisional Patent Application No. 62/903,617, filed on Sep. 20, 2019, which is hereby incorporated by reference. This disclosure relates to distribution and recirculatory systems for fluids, such as water, coolant and other materials, including by way of non-limiting example, heating systems, cooling systems, and potable and non-potable water distribution systems.

Conventional wisdom is that scale and corrosion in pipes and other distribution/recirculatory systems are each undesirable to any extent. It is well-known for example that corrosion degrades piping and can necessitate repair and replacement, and that scale buildup can constrict fluid flow and can interfere with efficiency of heating and cooling. It is common for operators of recirculatory heating and cooling systems to mechanically clean systems (e.g., to route out any accumulated scale) and to deliberately add chemicals to maximally suppress scale and corrosion.

### INTRODUCTION

In many systems, however, a certain amount of scale can actually be beneficial to overall health, efficiency and use of a fluid distribution and/or recirculatory system. “Scale” is used herein to refer to any protective layer or surfactant that helps resist corrosion, and is not limited to mineral scale. The presence of scale helps prevent the release of metal ions or/and particulate into a transported liquid, such as water or coolant. As a first non-limiting example, it should be understood that water distribution systems for many communities and buildings (e.g., older cities and buildings) still possess lead piping, joints and fixtures; while it is well-known that these elements can corrode and leach lead into water, and that such is generally dangerous to human health and to the environment, there may be little to no practical alternative to continued use of such a systems. For example, it might not be practical to introduce harmful chemical additives to such a municipal water supply to suppress lead pipe corrosion, and it might not be feasible to completely replace an entire distribution network (e.g., for the city of New York) or an old building. While excessive scale buildup can potentially lead to problems in fluid flow and distribution efficiency, as just discussed, a certain amount of scale can actually act as a protective barrier that suppresses or eliminates corrosion (e.g., thereby reducing introduction of lead or other harmful materials into water so as to fall within safe levels), particularly if scale is controlled as to constituency and extent of scale growth. As implied by these statements, there can be more than one type of scale (e.g., calcium carbonate, calcium bicarbonate, calcium phosphate, and other types of materials). As these example highlights, facilitating buildup of “just the right amount” of scale, and the right type of scale, and the careful control and management of a layer of scale (referred to herein as providing for proper “scale health”) can provide benefits to system performance which outweigh the impact of the potential problems mentioned above. These principles can in general be applied to nearly any material that can corrode for example (and without limitation) to network elements having selenium, cadmium, lead, copper, arsenic, chromium, beryllium, aluminum, nickel, uranium, iron and/or zinc.

Certain types of scale can be more beneficially applied than others. For example, lead-phosphate-based scale is typically much thinner and much more durable than limescale, and a regulated lead-phosphate scale layer can suppress leaching of lead and/or other harmful materials in distribution or recirculatory system, all while permitting continued system operation within safe, regulatory and/or desired efficiency limits. For example, a scale layer which does not unacceptably interfere with fluid flow rate, thermal exchange, water taste, or other desired metrics can suppress corrosion and facilitate indefinite, continued use of a lead- or copper-based delivery/distribution system. Similar examples exist for systems which may possess other potentially-harmful materials or degrading substances (including without limitation, selenium and chromium), and for systems other than water (e.g., recirculatory heating and cooling systems). That is, a deliberately engineered and/or controlled layer of scale can be used for corrosion minimization, avoiding leaching of harmful substances, and/or other purposes, in a manner that confers benefits. To provide still one more example, while it is known that excessive scale can interfere with heat transfer, but in some systems it can actually be desired to enhance thermal insulation while not unduly interfering with fluid flow, using a deliberately-engineered scale layer. Other exemplary benefits and applications also exist.

Note that scale buildup and breakdown can be the result of complex processes, and a variety of factors can contribute to scale creation, maintenance and degradation; generally speaking, pH, pipe type, constituent material, pipe surface roughness, ratio of pipe interior surface area to passing fluid volume, temperature, source of the aqueous matrix, alkalinity, anti-corrosion recipe implemented, the presence of sanitization agents (e.g., chlorine, fluorine, bromine, ammonia and other substances), presence of biological agents, presence of competing scale formation materials (e.g., calcium), season, flow rate (or lack thereof) and many other factors can each influence the amount of scale and type of scale for the network of interest. A brief example here might help convey an understanding of the difficulties involved maintaining a healthy water distribution network—biological agents can destroy scale and be harmful in a water supply and are typically regulated by the addition of sanitization agents—yet, sanitization agents can also destroy scale, and thus excessive treatment of water can also destroy scale.

### BRIEF DESCRIPTION OF THE DRAWINGS

FIG. 1A is a flow diagram showing one embodiment for monitoring for corrosion in a fluid distribution and/or recirculatory system.

FIG. 1B is a flow diagram relating to a development of a predictive model for forecasting degradation of and/or corrosion of one or more elements of a distribution/circulation network for a fluid.

FIG. 1C shows a distribution network for a fluid, in one nonlimiting example, potable or non-potable water.

FIG. 1D shows a recirculatory network for a fluid, in one nonlimiting example, coolant that will be used for purposes of heat exchange.

FIG. 2A shows one embodiment of a system that detects presence of unwanted metals in a fluid in a distribution or recirculation network, and that provides reactive capabilities.

FIG. 2B shows one embodiment of a system that predicts scale degradation and/or corrosion of one or more elements of a network for distributing or recirculating a fluid.

FIG. 3A is a flow diagram showing one embodiment for techniques for measuring and/or predicting corrosion in (or degradation of scale in) a distribution/circulation network.

FIG. 3B is a schematic diagram showing elements of a distributed measurement system for a network.

FIG. 3C is a diagram showing one possible format for logging data records representing measurements, and/or weights representing corrosion and/or degradation prediction parameters.

FIG. 4A is a schematic diagram showing operation of a voltametric device.

FIG. 4B is a schematic diagram of one embodiment of a system that measures degradation/corrosion of one or more test carriers and/or “coupons.”

FIG. 4C shows one embodiment of a system/process for measuring lead and copper concentration in an aqueous matrix.

FIG. 4D shows one embodiment of a set of techniques for repeatably measuring lead and copper concentration in an aqueous matrix.

FIG. 5A is an illustration of a lead pipe, which shows some of the complexity associated with lead corrosion and the formation (and degradation) of certain types of scale in a lead pipe.

FIG. 5B is a state diagram that shows different species of metal lead in a lead pipe (as well as different scale species that might be formed on the inside of the lead pipe from FIG. 5A).

FIG. 6A is an illustrative diagram showing another test apparatus with a build-in test carrier (i.e., either natively included or retrofitted by a customer of the test apparatus).

FIG. 6B shows exemplary graphs that might be produced from three types (classes) of tests performed using a test apparatus, e.g., to identify how various environmental parameters affect scale degradation and/or corrosion of metal.

FIG. 6C provides a block diagram associated with optional testing processes.

FIG. 6D provides another block diagram associated with optional testing processes.

The subject matter defined by the enumerated claims may be better understood by referring to the following detailed description, which should be read in conjunction with the accompanying drawings. This description of one or more particular embodiments, set out below to enable one to build and use various implementations of the technology set forth by the claims, is not intended to limit the enumerated claims, but to exemplify their application. Without limiting the foregoing, this disclosure provides several different examples of techniques that can be used to improve the detection and/or prediction of degradation and/or corrosion of a distribution/recirculation network for an aqueous matrix or other fluid. The various techniques can be embodied as software, in the form of a computer, device, service, cloud service, system, a localized or distributed network of multiple systems, a testing apparatus or measurement device, a database, related methods, or in some other manner. While specific examples are presented, the principles described herein may also be applied to other methods, devices and systems as well.

### DETAILED DESCRIPTION

This disclosure provides techniques for measuring and/or predicting corrosion in and/or health of a distribution/recirculation network for a fluid, such as by way of example, water or coolant. As alluded to earlier, the corrosion is typically manifested by the presence of unwanted metal in the fluid, for example, lead, copper or some other metal which may leach from piping or other elements used to carry the fluid in question. In some cases, this metal is harmful to human health (e.g., especially lead, chromium VI and other metals), while in other cases the metal represents unwanted degradation to the network of interest which is to be halted or corrected. In embodiments presented below, devices, systems and methods can monitor for the presence of a particular metal or metals in the fluid of interest, and can alert an operator or take more sophisticated action. In some embodiments, the process is more proactive, i.e., environmental parameters are monitored to predict corrosion and/or the degradation of an engineered/maintained layer of scale (i.e., as a precursor to subsequent corrosion). Still further embodiments discussed below provide an apparatus that can be used to “learn” characteristics of a particular network (or element thereof, such as a pipe, joint, fixture, vessel, etc.) and build a database that can then be used to predict scale degradation (e.g., prospective corrosion) and optionally take mitigating actions. Various techniques for using these various apparatuses and devices will be described. Other embodiments will be apparent from the discussion below.

This disclosure will be organized roughly as follows: (I) A first section will discuss techniques, systems and devices that can monitor a distribution or recirculatory network for the presence of unwanted metals in a fluid and optionally take mitigating actions; optionally these techniques, systems and devices can use a learned database (and/or correlation weights) customized for a particular delivery or recirculatory network or network element and/or can employ methods of building such a database and/or learning such weights, but these things are not required for all implementations; (II) A second section will discuss a voltametric measurement system and related techniques for measuring metal concentrations and perform speciation and aggregate metal testing (depending on metal type); (Ill) A third section will discuss measurement devices/test apparatuses adapted for optional use in connection with these techniques, systems and devices, and associated testing protocols; such a test apparatus, and its related method of operation, can be used to learn how environmental parameters characterizing a fluid lead to scale degradation and corrosion, and can optionally generate data that can be used to engineer and/or maintain a desired layer of scale that will serve as a buffer to corrosion; (IV) A fourth section will discuss exemplary processes; and, finally, (V) A fifth section will present final considerations. The devices and components of each section should be assumed to be optional, that is, not required for any other section or for other embodiments; also, mixing and matching components from the various examples presented below is expressly contemplated by this disclosure even if not illustrated in a single dedicated drawing or otherwise discussed on a dedicated basis.

Several additional terms used herein should be specifically introduced. First, “circuitry” can refer to analog or digital electronic elements (e.g., dedicated logic gates), either arranged as special purpose circuitry that necessarily performs a certain function when electrically motivated, or as general purpose circuitry (e.g., one or more processors) that is controlled or otherwise configured by instructions (software) so as to adapt that circuitry to perform a specific function and cause that circuitry to operate as though it was special purpose circuitry. “Processor” as used herein refers to a set of configurable hardware circuit elements or hardware circuit elements that can be controlled to perform any one of a number of different functions including, without limitation, an FPGA, microprocessor, microcontroller, whether or not embodied in a standalone die or as a discrete integrated circuit. “Instructions” and “software” typically refer to instructional logic for configuring and/or controlling operation of a processor. Such instructions are typically written or designed in a manner that has certain architectural features such that, when those instructions are ultimately executed, they cause the one or more general purpose circuits or hardware devices (e.g., one or more processors) to necessarily perform certain described tasks. “Logic” can refer to software logic (i.e., instructional logic) or hardware logic (e.g., a digital chip or board design) or a combination of these things. “Non-transitory” “media” or “storage” means any tangible (i.e., physical) storage medium, irrespective of how data on that medium is stored, including without limitation, random access memory, hard disk memory, optical memory, a floppy disk or CD, server storage, volatile memory, memory card and/or other tangible mechanisms where instructions may subsequently be retrieved by a machine (such as one or more processors). The media can be in standalone form (e.g., a program disk, solid state memory card, whether bootable or executable or otherwise, or in other memory) or embodied as part of a larger mechanism, for example, a laptop computer, portable or mobile device, server, data center, “blade” device, subsystem, electronics “card,” storage device, network, or other set of one or more other forms of devices. The instructions can be implemented in different formats, for example, as metadata that when called is effective to invoke a certain action, as Java code or scripting, as code written in a specific programming language (e.g., as C++ code), as a processor-specific instruction set, or in some other form; the instructions can also be executed by the same processor or common circuits, or by different processors or circuits, depending on embodiment. For example, “instructions stored on non-transitory machine-readable media” typically refers to software stored on disk or in other physical memory or storage, where the software is structured such that when it is later (ultimately) installed or executed by an operator or end user, it configures a machine (e.g., one or more processors) so that they operate in a prescribed manner. In one implementation, instructions on non-transitory machine-readable media can be executed by a single computer or processor and, in other cases as stated, can be stored and/or executed on a distributed basis, e.g., using one or more servers, clients, or application-specific devices, whether collocated or remote from each other. Each function mentioned in the disclosure or FIGS. can be implemented as part of a combined program or as a standalone software module (i.e., an invocable or callable program or subroutine), either stored together on a single media expression (e.g., single floppy disk) or on multiple, separate storage devices, or in the form of dedicated circuitry or circuitry combined with such software. Throughout this disclosure, various processes will be described, any of which can generally be implemented as instructional logic (e.g., as instructions stored on non-transitory machine-readable media), as hardware logic, or as a combination of these things, depending on embodiment or specific design. “Module” as used herein refers to a structure dedicated to a specific function; for example, a “first module” to perform a first specific function and a “second module” to perform a second specific function, when used in the context of instructions (e.g., computer code), refer to mutually-exclusive code sets; these code sets can be embodied as different code portions (e.g., different sets of lines in a common-program, or different routines embodied as respective parts of a common library) or otherwise as respective standalone routines, programs or files. When used in the context of mechanical or electromechanical structures (e.g., a “sample preparation module”), the term module can refer to a dedicated set of components which might include hardware as well as software); for example, an “encryption module” and a “network registration module” would refer to dedicated, mutually exclusive components for performing tasks of encryption and network registration, respectively, and they might be discrete code sets or have discrete mechanical structures, or both, depending on context. In all cases, the term “module” is used to refer to a specific structure for performing a function or operation that would be understood by one of ordinary skill in the art to which the subject matter pertains as a conventional structure used in the specific art (e.g., as a software module or hardware module as those terms would be understood in the context of computer and/or software engineering and/or circuit integration), and not as a generic placeholder or “nonce” or “means” for “any structure whatsoever” (e.g., “a team of oxen”) for performing a recited function (e.g., “encryption of a signal”). “Mechanism” as referred to herein refers to a unit that operates by mechanical action of some type and, once again, encompasses structures that would be ordinarily associated by those skilled in the art with a given type of function; for example a “sample extraction mechanism” typically refers to an electromechanically actuated mechanism that draws a liquid sample, typically of a defined volume, from a network of interest for purposes of testing and/or measurement as described herein, and can includes some type of vessel to store the sample and a motion activated syringe, electronically-controlled bleed valve, or some other type of electrically-controlled structure that is operated mechanically to draw a sample of interest. “Electronic” when used to refer to a method of communication can also encompass types of audible, optical or other communication functions, e.g., in one embodiment, electronic transmission can encompass optical transmission of information (e.g., via an imaged, 2D bar code), which is digitized by a camera or sensor array, converted to an electronic digital signal, and then exchanged electronically. Generally speaking, reference will be made herein to instructions such as computer code which, “when executed,” cause one or more processors to perform a specific task; this usage should be interpreted as referring to the intended design and operation of software (e.g., such as might, following software sale and/or distribution, be installed and executed by a software licensee or an end-user). An “engine” in the context of this disclosure typically includes code for performing a discrete set of tasks typically configured as a subroutine or function call; for example, a “rules engine” refers to a code set that manages and applies rules, which may be stored in a database, and takes or triggers actions specified by the rules. “Sanitization agent” as used herein means any substance used to treat a fluid to inhibit or eliminate biological agents as well as a byproduct of such agents; for example, a sanitization agent commonly used for water is chlorine, and its byproducts can include among other things trihalomethanes (THMs), haloacetic acids, haloaldehydes, haloacetones, haloacetonitriles and chloral hydrate. This disclosure uses the term “sanitization agent” to refer to these things because these are common sanitization byproducts tested for in a water distribution network and their presence can potentially be a factor in corrosion and/or distribution network health. THMs, in particular, head the USA EPA list of toxic and carcinogenic compounds highly regulated in drinking water and can include specific THM species of chloroform (CHCl3), bromodichloromethane (CHBrCl2), dibromochloromethane (CHBr2Cl) and bromoform (CHBr3). A “network” as used herein, when referring to a distribution or recirculatory system for fluid, typically refers to a set of elements used to distribute a fluid (e.g., liquid) for a particular application, i.e., it can include one or more pipes, joints, fixtures, conduits, channels, tanks or other storage elements, valves, chambers, cisterns, reservoirs, ducts, etc., which cooperate to distribute and/or recirculate the fluid (for example, a system that recycles distributed liquid for heating or cooling applications); each “element” or component typically refers to a given component, for example, a specific pipe (e.g., of a specific age and/or condition, constituency, manufacturer, etc.). “Network” may also be used herein to refer to a computer network e.g., a local or wide area network. A “joint” or “junction” refers to a coupling between two different elements (e.g., different types of pipes). A “fixture” refers to an element in a network of interest with a predetermined function other than simply to transport fluid of interest, for example (and without limitation), a faucet, a valve, a storage tank, coil, a heat exchanger, an orifice, etc. A “test carrier” refers to an element that is used to model or serve as a proxy for one or more elements in a network, for example, for one component of a fluid distribution or recirculation network up to an entire network (including all of its constituent components); a “coupon” more specifically refers to an actual element from the network of interest (or portion thereof) or other material which is intended as a representative sample for purposes of modeling constituent material of a specific network, e.g., a pipe that is still in service as part of the network, or a piece of the network which has been removed and which is to be used to model one or more structures in the network, or a sample having the same construction, manufacturer, material type, surface area-to-volume ratio, surface roughness, age and/or condition part or all of a network being monitored. “Environmental parameter” refers to any variable associated with or that can characterize the fluid being analyzed or modeled, directly or indirectly, e.g., it can include without limitation, time of day, flow rate, season, date, pH, alkalinity, concentration of certain materials, source identity (e.g., reservoir, cistern, river, an individual specific source (e.g., a specific river), concentration of metals or other materials, sanitizer presence, age or time, treatment history, and potentially any one of a myriad of other parameters.

### I. TECHNIQUES, SYSTEMS AND DEVICES TO MONITOR A DISTRIBUTION OR RECIRCULATORY NETWORK

A first embodiment provides techniques, systems and devices for monitoring a fluid distribution or recirculatory network. Without limitation, one example of a fluid distribution network is a municipal water supply for a community, which distributes potable water (potentially from many sources) to one location or a number of disparate locations; a more localized example can include a water distribution network for a building. An example of a recirculatory network can include a heat exchange system that uses fluid to convey heat from a first location to a second. One or more monitoring systems are applied to detect metal corrosion and/or to predict metal corrosion of elements (e.g., pipes) in the system, optionally taking reactive measures to reduce corrosion and/or to counteract a trench associated with the development of corrosion.

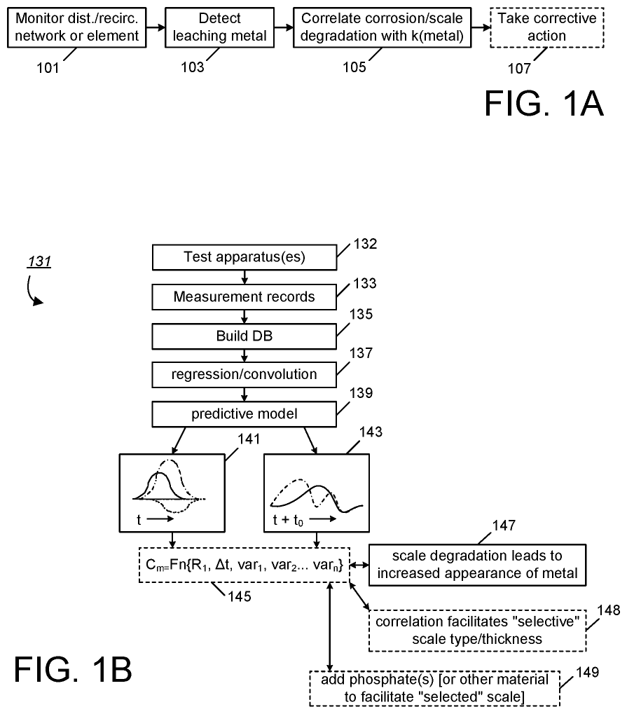

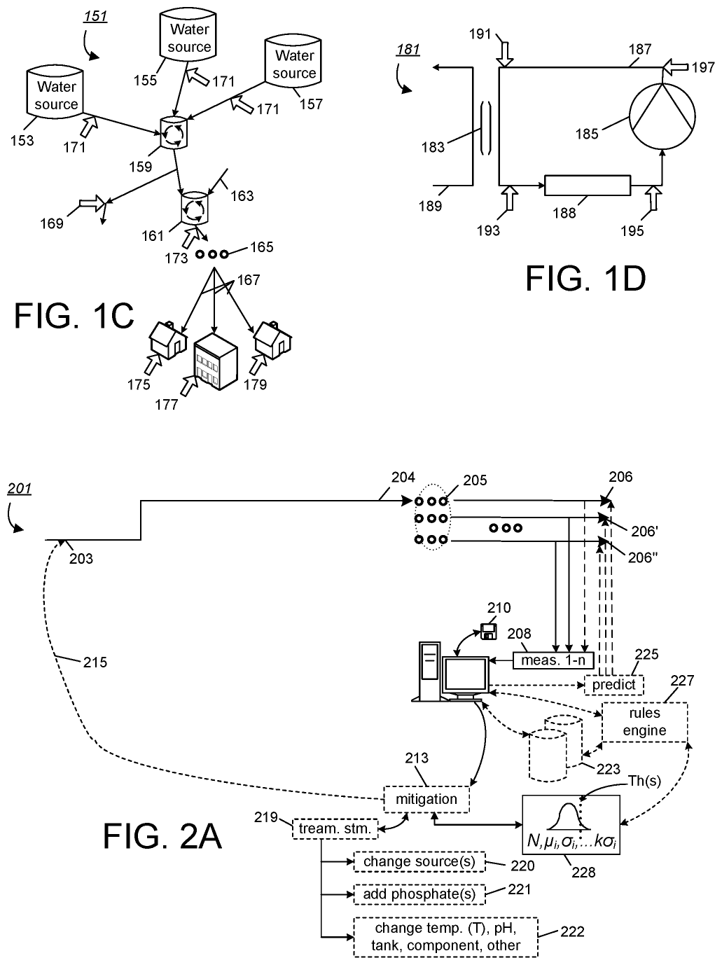

FIG. 1A illustrates such an embodiment. As seen in the FIG., one first monitors a distribution or recirculation network or an element (e.g., one or more components) in such a network, per numeral 101. The monitoring can include detecting the presence of and/or concentration of one or more metals that leach from the network or element, for example, lead, copper, aluminum, zinc, nickel, chromium, iron and/or any related species or compounds, or conditions that will lead to that leaching, per numeral 103. As will be noted below, in one optional embodiment, a voltametric measurement system can be employed in situ to perform metal detection and/or measurement. Per numeral 105, corrosion of the metal and/or the destruction/degradation of a protective layer of scale is then detected or predicted based on the measurements. Per optional process block 107, corrective action can then be taken based upon the detected and/or predicted corrosion or degradation. As non-limiting examples, additives can be introduced to a fluid, sources can be switched and/or other environmental parameters (e.g., pH, temperature, alkalinity, presence of certain compounds) can be corrected to counteract a detected or inferred trend. By reacting to (and counteracting) the presence of metal and/or measured or predicted degradation, the presented techniques and related systems can foster safe and/or continued use of a system, notwithstanding the possibility of corrosion under otherwise conventional use conditions.

FIG. 1B illustrates another embodiment, generally represented by numeral 131. The general embodiment represented by FIG. 1B can be used to test an existing network (or element or component of that network) and “learn” environmental conditions that lead to corrosion. One or more test apparatuses 132 can be used to test for presence of specific metals in trace concentrations, with a series of tests used to discriminate between trace presence of metal originally in the fluid of interest from metal released from corroding material in the network on an incremental basis. Acting under the control of suitable software, processor(s) and/or other circuitry, the test apparatus(es) can take repeated measurements over time to provide individual measurement records 133 and to, over time, build a database, per numeral 135. The software intermittently or continuously processes records (optionally weighted by time/age) and performs a convolution and/or regression to link degradation/corrosion of the one or more elements in the network with fluid and environmental characteristics, per numeral 137. In turn, this processing yields a set of factors/weights which can be used to predict prospective occurrence of corrosion, e.g., to identify a trend. In some implementations, this convolution and/or regression is updated and becomes more accurate as more measurements are made and/or the right contributing factors are identified, leading to a predictive model that provides an understanding of what corrosion/metal release will look like for a particular fluid and/or network of interest). With identification of the proper influencing factors (“metrics” or “weights” identified), these techniques then provide a system for localized measurement and/or prediction of degradation or corrosion that might otherwise be seen. Generalizing this problem to the example of water distribution for a large city, an entity such as a municipal water supply or even a business or apartment building in such a city can detect water conditions that can be expected to cause piping to release harmful metals into the water supply, and to effectuate mitigation which avoids corrosion and/or fosters proper scale health. Similarly, for a recirculation network (e.g., for heating/cooling), a company managing such a system can predict in advance conditions that will lead to degradation and/or increased maintenance costs, and can effectuate mitigating action that reverses trends and maintains system longevity. Numeral 141 conceptually denotes that modeling can be based on multiple metrics, each representing fluid and/or network metrics or environmental parameters (e.g., change in pH, flow rate, alkalinity, temperature, presence/concentration variation of one or more substances, and so forth, each represented by a different curve). Numeral 143 conceptually denotes that modeling can account for time-varying measured degradation and/or corrosion, for example, copper and/or lead concentration (conceptually represented by different curves), or variation in lead metal concentration observed in water, scale thickness, and so forth. Optionally, as represented by numeral 145, the system can build and hone an equational model that considers many variables (“var”), identifies suitable weights, and provides a predictive model for metal concentration and/or scale health (“Cₘ”). The specific design of suitable instructional logic (e.g., software) and/or hardware logic (e.g., processors and/or other circuitry) to effectuate measurement steps and/or identification of predictive models of interest is within the skill of a competent software engineer, given knowledge of the aqueous matrix of interest and its associated distribution network.

Note that as represented by numeral 147, the model 131 represented by FIG. 1B can be expressly or implicitly associated with a layer of scale and degradation to that layer of scale. For example, in a situation involving a lead or copper pipe for example, it is believed that a thin, protective layer of scale on the inside of the pipe in question, e.g., of the right type (such as formed in part based on the metal of the pipe or other element itself) acts as a barrier to corrosion, effectively insulated a corroding substance from the fluid carried by the network. As the conditions change, the scale layer is either built up or degrades, as a function of environmental factors such as pH, oxidation-reducing potential (“ORP”), temperature, alkalinity, presence (or absence) of phosphates in the liquid, and presence of other substances. Delays for example following change in environmental parameters (e.g., temperature and pH) can be followed by a period of scale degradation, followed by appearance of increasing concentrations of corroded metal in the fluid of interest. By performing the correlations described above, methods disclosed herein permit effective (e.g., indirect) identification of scale degradation and correction of conditions before the scale layer degrades completely and before metal concentration, representing corrosion, begins to rise. The environmental parameters leading to scale degradation can vary from fluid-to-fluid (e.g., a given fluid distribution or recirculation network may have presence of certain agents absent in other networks), and from element-to-element within a network (e.g., a pipe from a given manufacture, with a given history and age, might be more susceptible to corrosion in the presence of certain materials than another pipe in the same network, or the same type of pipe in a different network). For example, the material constituency of a certain, specific pipe, its age and history, its diameter (e.g., interior-surface area to fluid-volume ratio), surface roughness, and many other factors can vary even within a given network. By learning parameters specific to a network and/or to specific network element, or component (or a combination of two or more such specific components), the described system can provide for development of a customized set of parameters that accurately “learn”/adapt to the network (or component(s)) of interest. Note that while scale measurement can be indirect, there exist techniques for directly measuring scale constituency and thickness (e.g., electrostatic tests), and the use of these tests are also contemplated by the techniques described above. Also, note that there can be multiple types of scale, e.g., limescale (which can build up easily to significant thicknesses that obstruct fluid flow) as well as scales based on other materials. In embodiments discuss below, formation of certain scales (e.g., lead-phosphate-based scale, lead-carbonate-based scale and lead-oxide-based scale) are promoted over other types of scale (e.g., limescale); embodiments discussed below can prioritize or emphasize production and health of select scales (e.g., lead-phosphate over lead-carbonate over lead oxide), depending on scripted rules that adjust system parameters as appropriate. That is, as indicated by numeral 148, the disclosed techniques permit correlation of conditions that promote the development of the right type of scale, i.e., on a selective basis. Per numeral 149, one possible mitigatory action that can be taken is to selectively introduce phosphates to the fluid of interest so as to selectively engineer phosphate-based scale (or another material, i.e., so as to engineer or emphasize a selective type of scale). These options are not required for all embodiments.

Note that monitoring systems and/or test systems can be positioned almost anywhere in a distribution or recirculatory network of interest, as needed or desired, and that testing and/or control over testing can be performed locally or remotely at any one or more locations. FIG. 1C helps illustrate this conceptually, with numeral 151 representing a hypothetical distribution network for potable or non-potable water. The depicted network shows water being drawn from one or more sources (153, 155 and/or 157), with mixing represented by an icon 159 representing a blending tank, distribution to a downstream storage facility 161 and/or downstream blending with water from yet another source 163, and potentially other tiers or routing (represented conceptually by ellipses 165); numeral 167 represents delivery to one or potentially many end customer distribution points 175, 177 and/or 179. Each of these can be a downstream water company, a home, business, or other entity, each conceivably with one to many taps, faucets, and so forth. Numeral 169 conceptually denotes that, in one embodiment, a measurement system and/or test apparatus as variously introduced above (or per other embodiments discussed herein) can be installed at a central distribution point, by way of nonlimiting example, such as at a municipal water company site, with water output from test carriers optionally being shunted out of the system and discarded. Alternatively or in addition, a measurement system and/or test apparatus can be situated at other points, such as at individual water sources themselves, at locations adjacent to or intermediate to various pipes, joints or fixtures, or downstream nearer the point of delivery (i.e., as conceptually represented by numeral 173), all depending on specific implementation and desired goals. In one embodiment, as noted above in connection with FIG. 1A, multiple measurement points (measurement systems) and/or a predictive system can be based at point 169, or potentially at point 173, or adjacent points of customer delivery (e.g., at points 175, 177 and/or 179). As noted earlier, optionally, if a test apparatus such as described in FIG. 1B is used, this enables generation of a model which learns a specific distribution network and converges toward a model which predicts corrosion and/or scale health based on conditions observed by the network e.g., at any of points 169, 171, 173, or any combination and/or permutation of distribution network nodes.

FIG. 1D presents an embodiment 181 based on a hypothetical recirculation system, for example, an industrial power plant or other system that uses a fluid (e.g., a coolant) to provide for thermal transfer. Generally speaking, such an environment includes an element 189 that is to be heated or cooled; in the FIG., element 189 is depicted as by a set of arrows to connote a flow path, but this is not required, e.g., element 189 can represent for example a stationary or moving object (e.g., a turbine, a heating system embedded in a floor of a building, and so forth). Numeral 183 refers to a heat exchange configuration where pipes (or other conduits) 187 convey a fluid in proximity to a surface or object that is to be heated or cooled, while numeral 188 refers to a heater (or cooler, e.g., condenser), and numeral 185 refers to an optional pump (e.g., used to drive fluid circulation, if needed). As should be appreciated, it may be desired to measure any component in such a system for corrosion (and/or for prediction of scale degradation), or for the network at large; to this end, numerals 191, 193, 195 and 197 denote optional measurement points, i.e., where a measurement system and/or test apparatus can be installed to draw samples and/or take measurements for purposes introduced above. Once again, it is contemplated also to have a single system draw and/or process samples drawn from multiple points, i.e., with multiple intake ports and a selection mechanism.

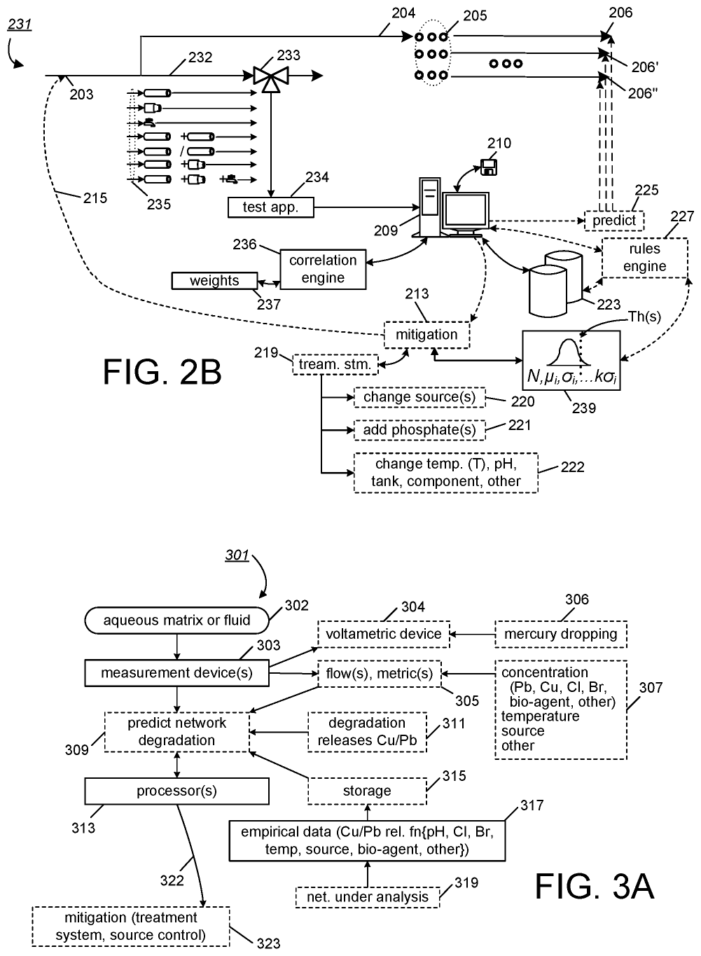

Specific embodiments will be presented below which (a) permit dynamic reaction to conditions, e.g., to detected metal presence in the liquid of interest (depicted in FIG. 2A), (b) use one or more test apparatuses to “learn” weights and/or data that can be used to predict scale degradation and/or trends that may lead to corrosion (FIG. 2B). All possible permutations and combinations of the various components of these systems, without any elements being “required,” are also specifically contemplated.

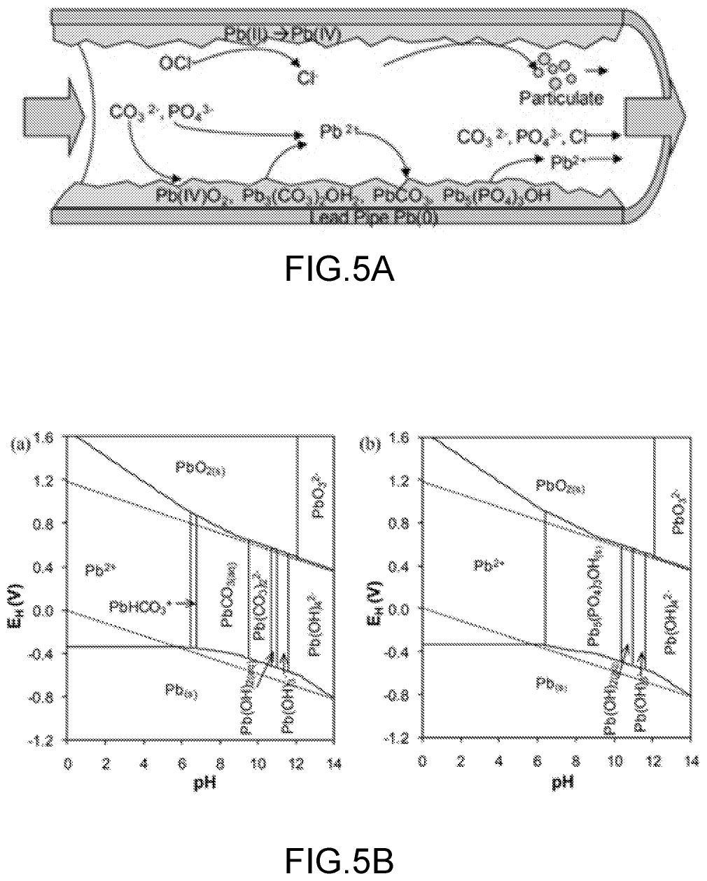

FIG. 2A shows an embodiment of a system 201 used to test for corrosion in a fluid, e.g., a liquid. As before, the liquid is carried by a distribution or recirculation network, which features one or more pipes, joints, fixtures, conduits or other elements made at least in part of a metal material. The metal material, under certain circumstances, corrodes, thereby transferring metal to the liquid. The metal can be transferred in various forms or compounds (i.e., species of the particular metal at issue). The metal of interest should be assumed to be lead or copper but, as noted earlier, and depending on application, it can be any metal including without limitation aluminum, zinc, nickel, chromium, iron, etc., in the form of free metal or any related compounds, and it can also be a combination of multiple metals and/or multiple metal species. The liquid travels through one or more paths 204, traversing as it does so one or more components having metal materials (represented by ellipses 205) and ultimately arriving at one or more measurement points, labeled 206, 206′, 206″, etc. At these points, measurements are taken, of environmental parameters associated with the fluid, or of concentration(s) of the metal of interest, or both, as denoted by numeral 208. As represented by numerals 209 and 210, the measurements can be provided to circuitry and/or instructional logic embodied as one or more processors being managed under the control of suitable software (i.e., represented as a symbolic computer and floppy disk icon). This hardware or software logic (209/210) optionally detects the occurrence of corrosion or, in other embodiments, a trend representing loss of a deliberately-maintained scale layer, or a trend otherwise correlated with corrosion, and effectuates mitigation actions (i.e., per numeral 213). These mitigation actions can include control processes as represented by path 215 which adjust the environmental parameters (so as to reduce corrosion or otherwise respond to counteract a detected trend). For example, as represented by numerals 219, 220, 221 and 222, these actions can include optional control over one or more treatment systems, which trigger a change of liquid source, the addition of phosphates, carbonate, bicarbonate or other materials that will enhance selective scale production, and/or effectuate processing so as to adjust temperature, pH, ORP, alkalinity, storage tank, components, and so on. In one embodiment for example, phosphate (e.g., polyphosphate) can be added to emphasize the formation of lead-phosphate scale. For embodiments which measure water parameters and predict trends, as denoted by numeral 225, the hardware/instructional logic (209/210) effectively predicts that corrosion will occur if conditions are not changed. For these embodiments, the hardware/instructional logic (209/210) can provide access to a database and/or one or more control factors (represented by icon 223) and a rules engine 227, which is scripted to take certain actions in response to certain conditions. For example, it might be for a particular system that scale degradation and ensuing corrosion are expected to occur as a function of a prolonged period of oxidizing water conditions and/or acid, neutral or base pH, and the absence of phosphate (see generally, FIG. 5B, discussed further below); rules for example can be scripted to take specific actions at specific times to restore phosphate dosing and to more tightly control pH, so as to reverse or offset a detected trend and/or enhance production of a selected type or form of scale. There may be more than one combination of environmental parameters that are correlated with corrosion and are monitored in a given system (i.e., with respective sets of actions being triggered), and conversely, conditions not directly associated with corrosion (e.g., excessive limescale buildup) that are also to be monitored and negated; various rules can be developed by those skilled in the art who are familiar with the networks at-issue, e.g., in observance of scripted rules, the hardware/instructional logic (209/210) can trigger mitigation actions 213 as desired to effectuate suitable responses. In one contemplated implementation, the mitigation can include simply generating an operator alert or a message that otherwise gets displayed to an operator (e.g., announcing that corrosion is occurring or predicting scale degradation, and/or suggesting an appropriate control protocol); in other contemplated implementations, the rules can be configured to take automated actions (as introduced previously, per path 215).

FIG. 2B shows an example implementation 231 that is similar to the one seen in FIG. 2A, but in FIG. 2B, it is assumed that the network is not being tested for instantaneous metal presence (e.g., corrosion) but simply for factors that can be used to predict corrosion trends. [Of course, testing mechanisms such as represented by numeral 208 in FIG. 2A can optionally also be used in the case of the system in FIG. 2B.] In FIG. 2B, elements having numbers introduced with respect to FIG. 2A should be assumed to be the same as were introduced in association with FIG. 2A.

FIG. 2B shows a branch path 232 from the main distribution/recirculatory system, and an associated sample extraction mechanism 233 (depicted schematically as a three-way valve). A test apparatus 234 (as introduced earlier) can be installed in connection with such a network to perform measurements on samples of the liquid at-issue and to “learn” conditions that can be used to predict scale degradation and/or corrosion. Such a system optionally relies on one or more “test carriers” (depicted as one or more sample pipes, joints or other elements, 235), and passes sampled liquid past these test carriers in order to detect release of metal under various conditions and time constraints (i.e., presumptively as a consequence of scale degradation and/or chemical reactions); such a test apparatus can feature built-in test carriers (e.g., sample lead or copper pipes for example), but in certain embodiments, the test apparatus can feature a set of universal couplings for a customer to modularly connect a “coupon” (e.g., a component or material taken directly from the network of interest, such as a small piece of old pipe or a joint taken directly from the network of interest, so as to more closely model materials existing within the specific network). The use of a test carrier and/or coupon is not required for all embodiments. Example tests which can be performed to develop useful prediction data will be further described in sections below. Data from testing is provided to the hardware/instructional logic (209/210) which optionally implements a correlation engine 236 (e.g., based on regression, convolution and/or related techniques), which can generate data for the depicted database 223, and also generate weights 237 which can then later on be applied to proactively control environmental parameters. That is, the rules engine 227 can feature tests which are performed on the basis of intermitted measurements 208 and apply the learned “weights” in order to detect “events” that are pertinent to scale degradation, scale type discrimination and/or corrosion; once such an event is detected, the rules engine can also then implement scripted or other responses, as described above. Such is not necessarily required for this embodiment (e.g., a test apparatus 234 can be used simply to learn data particulars for a network or network element or component at issue, so as to enable later optional control to avoid corrosion trends. As an example, it is possible for an implementation to generate data that will be stored on non-transitory media, where the data represents corrosion/trend analysis that may later be put to use in managing a fluid distribution/recirculation network.

### II. TECHNIQUES, SYSTEMS AND DEVICES TO MONITOR/TEST METAL CONCENTRATION

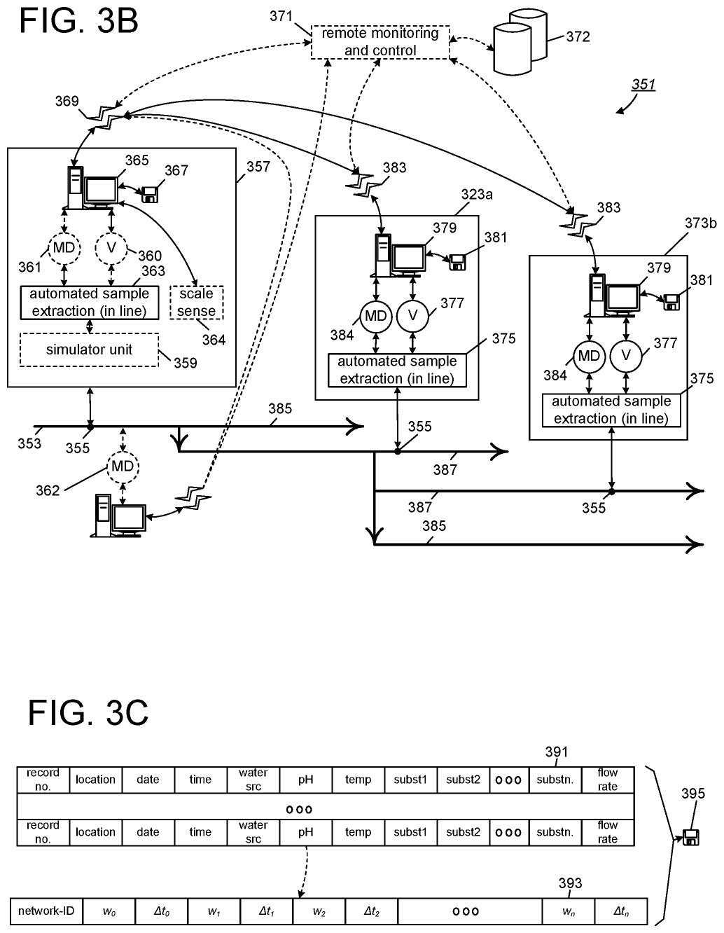

FIG. 3A shows techniques 301 used by a device or system to measure corrosion and/or metal concentration in an aqueous matrix or other fluid 302. One or more measurement devices 303 are used to capture characteristics of the aqueous matrix or fluid 302 of interest; each measurement device can optionally be a voltametric device 304, and/or a device that measures or determines flow rate(s) or values of other metrics, per numeral 305. As denoted by numeral 306, if a voltametric device is used, the device is optionally a self-contained in-situ device having a mercury dropping electrode (e.g., with a system that recycles and cleans mercury with little to no required mercury disposal). Such a system advantageously can be configured to detect metal concentrations in even trace quantities (e.g., parts-per-billion, or “ppB”). Per numeral 307, the measured characteristics once again can include any desired materials or characteristics which may influence network degradation or corrosion, for example, substances present already in the aqueous matrix or fluid (e.g., specific metals such as Cu and/or Pb, sanitization agents such as Cl/Br or their various compounds, biomatter, etc.), temperature, aqueous matrix or fluid sources, alkalinity, presence of or absence of phosphates or other substances, water age at various points in the network, pH, ORP, and/or other characteristics. For systems which measure metal concentration (e.g., lead or copper in a liquid, or concentration of another metal), concentrations can be logged and correlated with other data, or compared to a threshold (e.g., to determine whether trace concentrations are within acceptable limits), with operator alerts or automated control actions taken based on these measurements. These characteristics can also be optionally used to measure, learn and/or predict scale degradation within a network of interest and/or a trend toward future corrosion, per numeral 309, based on data stored in non-transitory storage 315; by way of non-limiting example, stored data can optionally include empirical data which will correlate observed/measured characteristics (e.g., change in temperature, pH, bioagent or sanitizer presence) with loss of a desired type of scale and/or expected degradation/corrosion, over short term, long term, or both, per numeral 317. In at least one contemplated application, the empirical data can be previously measured data/effects for a specific network or specific network element of interest (“net.”) 319, for example, based on the specific materials used in a network, their associated age/state/health and (implicitly or otherwise), metrics such as surface roughness, pipe interior surface area-to-fluid volume ratio, and other, similar factors. Once again, each of these steps/tasks can be controlled by processor(s) and/or other circuitry 313, optionally under auspices of suitable software. Based on measure or predicted degradation/corrosion, the techniques can then optionally control/generate a request for mitigation measures 323, for example, specific treatments for the aqueous matric or fluid of interest (e.g., reduction or increase of sanitization agents, specific types of filtering for the liquid/fluid, source selection switching, issuing an advisory to customers such as discussed previously, alleviating low flow rate conditions, and/or other measures). In at least one contemplated embodiment, the one or more processors and/or other circuitry 313 generate automated control parameters, for example, issuing commands or recommendations that will cause one or more systems to automatically switch from one source to another (or to effectuate specific treatment, e.g., water treatment) to remote systems in a manner not requiring direct human involvement, or calling for operator confirmation before execution). In other embodiments, the one or more processors and/or other circuitry 313 can generate an alert (e.g., email, voice mail, audible or visual alarm and so forth) for delivery a human operator if degradation/corrosion requires human involvement, e.g., based on rules and/or threshold comparison as previously discussed.

FIG. 3B shows a distributed measurement system 351 that uses multiple measurement devices to perform monitoring in a distribution or recirculatory network. A network receives an aqueous matrix or other fluid via an input 353 and conveys that aqueous matrix of fluid through one or more network nodes 355 for distribution via (optional) branch paths 385 and 387. As shown in the FIG. a first system or apparatus 357 is positioned to measure the aqueous matrix passing at one of the nodes, in this case, at a central distribution point (though this is not required for some embodiments). As one nonlimiting example, it could be that this first system or apparatus 357 is positioned at a central storage tank or distribution center of a water supplier system, who will distribute water to end customers via branch paths 385 and 387; as mentioned, a similar node-based configuration can also be extended to recirculatory systems. This first measurement system or apparatus is seen to have a simulator unit, optionally having one or more built-in test carriers, that will have the aqueous matrix or fluid passed through or past those carriers and will be monitored to detect scale health and/or degradation and the presence of corrosion; note that the system can simply be implemented as a device which measures instantaneous metal concentration. This first system or apparatus 357 can have one or more voltametric devices 360 to detect certain metals present (i.e., which can arise from degradation of the one or more test carriers or otherwise from a metal material within the network at-issue). In addition, the first system or apparatus 357 is also seen as optionally having one or more other measurement devices (“MD”) 361, for example, one or more of a flow meter, pH sensor, temperature sensor and other types of inputs which indication specific variation in characterizing metrics for the fluid in question, i.e., that can be correlated with short and long term corrosion and scale buildup and/or degeneration or otherwise with the presence of metal in the liquid being measured. As noted by numeral 362, these measurement devices can also be remotely installed, for example, to generate indications of localized or average flow rate or age which affect the sampled/subsampled water parameters, and similarly, statistical metrics such as average temperature, average pH and so forth can also be used (i.e., which may be correlated to degradation or corrosion). In the example of the system of FIG. 3B, these measurement devices as seen to be included as part of the first system 357. An automated sample extraction mechanism 363 is used to draw samples and provide those samples (or subsamples) to the various measurement devices on an intermittent or calendared basis (e.g., for tests repeated hourly or at other scheduled intervals). The system can also, as mentioned, have multiple ports for sampling a fluid from different measurement points in a network (or for different text carriers or coupons), e.g., with a manifold and/or selector used for sample multiplexing. The first system or apparatus 357 in this example also optionally includes a scale sense unit 364, for example, configured to measure scale/barrier layer health via an electrostatic or current flow test, in which a measured parameter varies as scale health is degraded, or to indirectly calculate scale thickness, uniformity and/or type (e.g., as a function of metal concentration changes); this permits sensed scale health variation to be correlated with short and long term variation in measured environmental parameters, and to correlate proper scale health (i.e., promotion of a desired amount of scale) with the same or other metrics, such that a predictive model can be used so as to manipulate and maintain future scale health and discrimination between scale species (i.e., thereby providing a desired buffer to future corrosion). As noted earlier, an electronic control system (or subsystem) for apparatus or system 357 controls the various depicted elements including the schedule for drawing samples and performing the various measurements, with the electronic control system being rooted in this case in a one or more processors (represented by a computer icon 365) and software (instructions on non-transitory media, 367). The control system in this case also includes a modem for exchanging data via a local area network (“LAN”) or wide area network (“WAN”) with other computing devices, as represented by remote transmission icon 369. The recorded and/or measured data can include differential measurements as described earlier (i.e., to isolate metals and/or corrosion from a specific test carrier under consideration) and can be in a record-based format as described earlier, with individual records either being locally stored or transmitted to a remote destination (e.g., via LAN or WAN to a remote monitoring and control system 371), for remote storage 372. The depicted distributed measurement network 401 also includes one or more remote monitoring stations (i.e., second systems or apparatuses), used to provide additional data from distributed locations or for other metals or metal species; in connection with FIG. 3B, two such remote monitoring stations 373a and 373b are shown, but it should be understood that any number of such stations can be used, e.g., three or a greater number. In this depicted embodiment, these stations are seen as monitoring network nodes 355 along branch paths 387, but not along branch paths 385, with feedback being based on a sampling provided by a non-exhaustive subset of points of distribution of the aqueous matrix or liquid (e.g., potable or non-potable water). Each monitoring station 373a and 373b is seen to be identical in design, though this is also not required for all embodiments. As depicted, each station optionally includes a voltametric measurement device 377 (with chemical consumables appropriate to one or more specific metals to be measured, as described in connection with the incorporated by reference documents), and with an automated sample extraction mechanism to draw samples in-line, i.e., directly from the network, preferably at points close to end customer distribution. Each station also optionally includes an electronic control system to perform automated measurements, once again including one or more processors 379, instructional logic (instructions stored on non-transitory media 381) and a modem 383 for remote communication and reporting of results. Each station 373a/373b also optionally includes one or more other measurement devices 384 to measure local water flow characteristics, for example, localized flow rate, temperature, pH, sanitization or bioagents present, and so forth, as has been described earlier. Measurement results, including concentrations of specific metals and/or specific metal species or compounds, are relayed via LAN or WAN, either to first system or apparatus 357 or to a remote monitoring and control system 371 for purposes of reporting metal presence (or concentration greater than specified thresholds), raising alerts, and/or for correlation and/or regressive analysis. As was noted earlier, using devices to log data in association with measured environmental parameters permits generation of a more accurate predictive model that can “learn” a specific distribution network of interest (or specific element of interest in a network, e.g., a specific pipe, joint or fixture), by permitting correlation of predicated degradation/corrosion with detected metals which have actually leached into the system, as detected by monitoring stations 373a/373b. While in some contemplated embodiments, each node can have an associated monitoring station 373a/373b, FIG. 3B indicates that a subset of nodes 355 of the network can be monitored for purposes of providing feedback, while still providing an accurate basis for refining a prediction model and controlling distribution of the aqueous matrix or fluid in question so as to promote scale health and to counteract conditions which might lead to future corrosion or degradation.

FIG. 3C shows one possible record format for logged data 391, with such data, and/or weights 393 (respective to any number of desired environmental parameters), being stored on non-transitory media 395. In one optional configuration, the weights (if a weighting system and/or correlation factors are used) can have associated time constants, representing “how soon” a particular factor influence degradation and/or corrosion. For example, due to the chemical and/or biological processes involved in corrosion, certain factors (e.g. such as temperature) may have a much faster ability to destroy scale and/or promote corrosion than other factors—in addition to a weighting (representing how strongly an associated environmental parameter influences corrosion), it is also possible to determine associated time factors (e.g., Δtᵢ) representing time-weights respective to some or all of the environmental parameters under consideration, and to store these factors for subsequent prediction purposes.

### III. EXEMPLARY MEASUREMENT DEVICES/TEST APPARATUSES

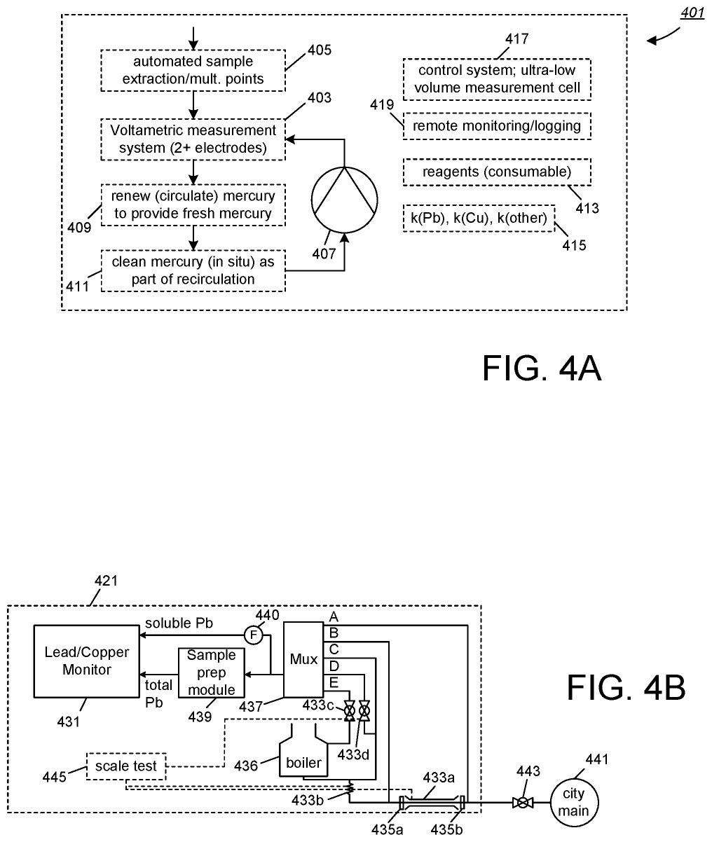

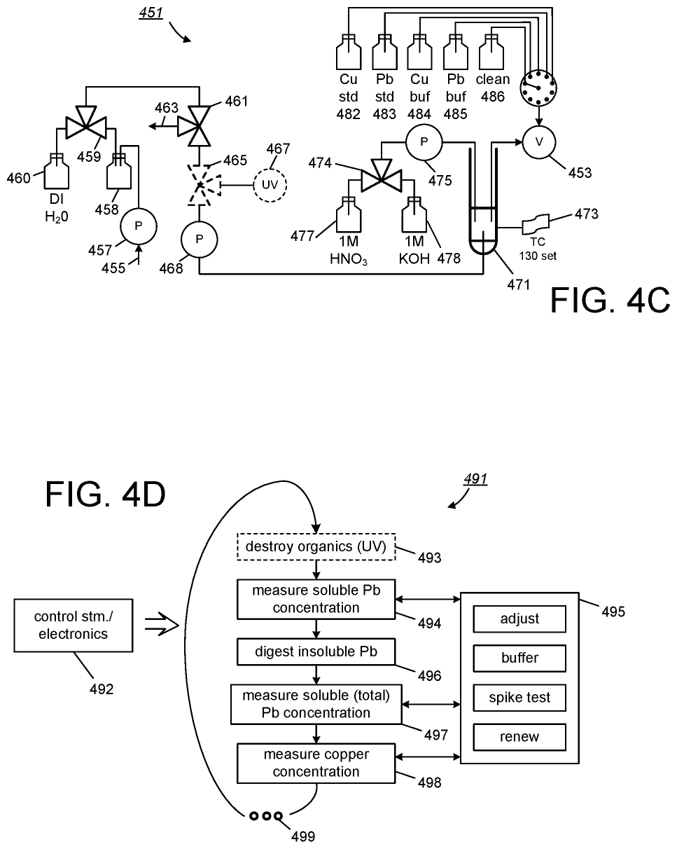

FIG. 4A shows a block diagram of an exemplary measurement device 401. Such a device is optionally rooted in a voltametric measurement system having at least two electrodes 403 (e.g., a system with reference, auxiliary and working electrode, optionally with a “dropping mercury electrode,” with built-in mercury cleaning and recycling, for example, as is described in our US Patent Publication Nos. (“USPB”) 20180136161 and 20190257788, which are also hereby incorporated by reference). Generally speaking, such a system features automated sample selection and/or extraction 405, one or more pumps 407 for extracting samples, transporting samples and/or renewing mercury, multiple cleaning systems for renewing mercury in-situ 409/411, localized reagent supply and mixing (and exhaust) 413, processing of concentrations of lead, copper or other metals 415, use of an ultra-low volume (e.g., 5.0 mm) measurement cell and a localized control system for performing calculations and otherwise processing results 417, and electronic connections support for local or remove reporting of numerical results 419 (e.g., by LAN or WAN relay).

Samples and/or subsamples can be drawn by a sample extraction mechanism, which for example, uses a three-way valve to selectively draw samples of interest on an automated or calendared basis, or at detection of predetermined “events,” all under auspices of the depicted electronic control system. For example, in one application, it might be desired to perform all such tests on an hourly schedule using a consistent volume of liquid; in a different application, the scheduling of tests can be made to vary depending on substance being monitored (e.g., lead-related tests every hour, copper-related tests once a day, and so forth). The desired scheduling will, naturally, be dependent on application, with scheduling typically being controlled by software (instructional logic). In applications where samples are drawn from inline elements in a distribution or recirculation network, a sampling mechanism can use a vessel having a predetermined sample volume and a level sensor or motion controlled syringe to detect when the required volume has been drawn. For example, such a system can draw, e.g., a fixed volume of a liquid, for example, 100 ml of liquid, drawn at a specific time; the control system then causes a pump or other fluid transfer mechanism 407 to draw in successive measurement cycles fixed volume subsamples, for example, a 5.0 ml subsample, to perform a specific test of interest (for example, to test for presence and/or concentration of a specific metal (such as lead or copper), thus permitting many different measurements from a larger single sample to be performed amongst the various measurement cycles. Naturally, a larger or smaller sample is taken in alternative implementations, e.g., for purposes of performing only a single test, a small number of tests, or potentially dozens to hundreds of tests. The nature of the tests performed can vary according to application, and can feature many tests for a substance (e.g., a particular metal of interest) for purposes of determining concentration. For example, a variety of such techniques are discussed in USPB 20200003745 (a national stage entry of International Application PCT/US17/38022, which is also hereby incorporated by reference); generally speaking, this disclosure discussed techniques for measuring aggregate forms of a particular metal, such as selenium, and techniques for measuring concentration of various species, by converting between metal forms, removing organics and so forth. While this latter patent application primarily exemplifies selenium speciation and aggregated selenium measurement, its techniques can be applied to other metals through straightforward extension by those having ordinary skill in the art including for example tests for lead that (without limitation) (a) detected/soluble Pb(II) without sample processing to remove/destroy masking organics, (b) detected/soluble Pb(II) following destruction (e.g., via UV exposure) of organics, (c) detected/soluble Pb(II) following subsample treatment (e.g., via a 0.1-1M nitric acid solution and accompanying heating process) to dissolve any insoluble lead forms, to convert those forms to soluble Pb(II), with or without any organics removed/destroyed, (d) processing to convert other forms of Pb (e.g., Pb(IV)) to Pb(II) to measure concentration of various metal species, and/or (e) any combination or permutation of the above. [See again, FIG. 5B, discussed below.] These tests can be extended to copper and/or other metals, and can be variously performed using subsamples for purposes of identifying and measuring individual metal species, for converting between metal forms (e.g., insoluble and soluble specific forms of lead, copper or other metals). As noted, the measurement device 401 can include optional measurement mechanisms for any desired environmental parameters including without limitation biomatter, pH, temperature, calcium presence, carbonate or bicarbonate concentration, phosphate concentrate, flow rate and other characteristics of interest, as these characteristics existed for the aqueous matrix at the time when the corresponding sample was drawn. In one embodiment, for each measurement, the electronic control system and/or its software creates a measurement record such as was exemplified above for FIG. 3C, each with fields such as “record number” (an index unique to each record), “location” (e.g., a unique identifier identifying a place where each sample was drawn), “date” and “time” when the associated sample was drawn (or alternatively, when measurement was performed), “water src” (i.e. identifying the source of the aqueous matrix, for example, whether water sampled is from a specific well, aqueduct, storage tank, and so forth), “pH” to designate pH measured for a particular sample, “temp” for temperature, “subst1” . . . “substn” for concentration readings of various predetermined substances, and “flow rate” identifying flow rate at the time the measurement was taken or at a particular point in time. As should be apparent, many other formats can be equivalently used instead of or in addition to the multi-parameter record just exemplified; for example, a simplified format might feature (in addition to time, date, and location fields), a field designating measurement type (“type,” e.g., “pH,” “flow rate,” “Pb(II) concentration,” etc.) and a single payload field corresponding to the designated measurement type (i.e., such that each record would represent a single characteristic). It is within the level of one having ordinary skill in software design to design and/or to customize a data record format appropriate to the application of interest.

FIG. 4B shows another possible implementation 421 of a system for measuring degradation/corrosion. A lead/copper monitor 431 can comprise a voltametric device from FIG. 4A (including an associated electronic control system); in this example, the lead/copper monitor is part of an integral system that includes at least one test carrier 433a. This test carrier can be a piece of metal (e.g., pipe) that is intended to model a network of interest or component or element of such a network (for example, a lead pipe, and thus the test carrier is advantageously configured or adapted to have a similar metal material as will be found in the network or component of interest). Optionally, a test apparatus (421) is sold in a manner such that a customer can install whatever test carrier the customer wants (e.g., a piece of metal intended to serve as a model for the network in question or portion thereof). To this effect, the device/apparatus can be designed to feature modular connectors 435a/b so as to connect whatever component is desired by the customer. Such a component can advantageously also be a “coupon,” e.g., a piece of a network excised (cut out) by a customer and installed, so as to model a specific pipe, joint, fixture or other component of interest; for example, a customer having aging lead pipe that is of concern may elect to remove a short section of actual pipe from a network of interest (e.g., “5-inch long section of 3-inch pipe”) and pass sampled fluid through that pipe. Advantageously, the modular connectors 435a/b are designed so as to snugly mate with a variety of pipe and/or fixture sizes as might be selected by a customer, for example, having pressure fittings and/or rubber gaskets which are designed to snugly fit over a variety of pipe sizes and establish a liquid-proof connection.

Whatever material is used to a test subject (e.g., as a “test carrier”), the device optionally features a receptacle or connection mechanism such that the system as sold has an adapter intended for easy/ready connection to a water distribution/circulation network. In this case, for example, the system 421 is seen connected to a city water main 441, such that the system receives a supply of potable water via valve 443. Test carrier 433a in this example can be a lead pipe, and the system can optionally feature additional test carriers, such as (without limitation), a copper pipe 433b, a first brass valve 433c, a second brass valve 433d, etc. A boiler 436 supplies hot water, such that (in this example) water output by brass valve 433d experiences potentially different degradation/corrosion that can be measured relative to the first brass valve 433c. A multiplexer 437 is used to switch between various inputs; as labeled in the FIG., input “A” represents water as obtained from the connection to valve 443, input “B” represents water corresponding to input “A” but which has been passed through lead pipe 433a, input “C” represents water corresponding to input “B” but which has been passed through copper pipe 433b, input “D” represents water corresponding to input “C” but which has also passed through brass valve 433c and input “E” represents water corresponding to input “C” but which has passed through boiler 436 and brass valve 433d. Naturally, these specific configurations are optional and different types (and/or different combinations/permutations of types) of fixtures can be used for purposes of simulation. Test carriers 433a-d, boiler 436, multiplexer 437, sample prep module 439 and filter 440 can be thought of as an implementation of the simulator unit 359 from FIG. 3B. On a desired basis, intermittently or according to a preset schedule, the lead/copper monitor 421 samples the various inputs to measure lead concentration and/or copper concentration, which are then passed to the electronic control system (or alternatively, to a remote monitoring and control function) for correlation with various variables/metrics which characterize the fluid of interest at the time of sampling (e.g., pH, ORP, surface roughness, surface area-to-volume, temperature, sanitization agents present, alkalinity, corrosion inhibitors, bioagents present, water age, and so forth). As noted earlier, measurement of these variables/metrics can be made a function of system of 421 depicted in FIG. 4B, though are not specifically illustrated in FIG. 4B. Soluble lead can be measured by optionally passing a multiplexed input through filter 440 (to filter particulate lead) before passing the input to a sample vessel, and total lead can then be measured by passing a multiplexed input through sample prep. module 439, which heats the sample and adds acid to digest particulate lead and convert it to soluble form. In the case of the embodiment depicted in FIG. 4B, all forms of lead are assumed to be Pb(II), and other forms of lead such as Pb(IV) are assumed to be negligible, although in other embodiments, it is also possible to convert such other forms of lead to Pb(II) for purposes of speciation, (e.g., as described in the incorporated by reference document dealing with selenium speciation, adjusted for the use of suitable chemical reagents). For the embodiment of FIG. 4B and for some water distribution applications, particulate copper and other species' of copper can be assumed to be negligible, such that soluble copper can potentially be measured without passing through sample preparation module 439; once again, in other embodiments, additional processing can be performed to measure particulate copper if desired or other forms of copper. As indicated by the presence of optional block 445, the depicted system can also be configured use current flow or electrostatic tests, as appropriate, to measure variation of a protective scale layer in each of the depicted test carriers. By extension, processes similar to these can be performed to effectuate isolation and speciation of other metals such as selenium, cadmium, lead, copper, arsenic, iron, chromium, beryllium, aluminum, nickel, uranium, zinc and/or other metals.

Reflecting briefly on the system depicted in FIG. 4B, a system/device can be manufactured and sold which includes, or is modularly connectable to, one or more test carriers and/or coupons for purposes of measuring corrosion/degradation attributable to a fluid, e.g., water. Measurements obtained from such a system/device can be correlated with one or more variables/metrics which characterize that fluid, such as seasonal variations, flow rate, temperature, pH, ORP, surface roughness, surface area-to-volume, alkalinity, sanitization agents used or present, other materials present, and other factors.

FIG. 4C shows a schematic 451 showing one embodiment of preparation and processing for measurement of lead and copper concentration in a fluid, such as water or another liquid. Once sampled/processed, the fluid can be supplied to a voltametric measurement device 453, seen at the right-side of the FIG. A sample is drawn via intake 455 under the governance of a motion-controlled syringe or pump 457 (or other sample extraction mechanism), into a sample vessel 458. Typically, a sufficient size sample will be drawn to perform multiple tests. In this embodiment, total lead, soluble lead and soluble copper will be measured from subsamples taken from a common sample in reaction vessel 458, though it is also possible to perform these tests on different samples, drawn at different times. A three-way valve 459 provides selection between a subsample drawn from sample vessel 458 and deionized water 460, the latter being used to rinse conduits in preparation for ensuing measurements. A second three-way valve 461 is controlled to either pass the deionized water/subsample, or to exhaust waste water from the system via path 463, to a drain (not shown), while a third optional three-way valve 465 provides for optional UV treatment (via UV source 467), for example, to destroy organics which might mask voltametric measurement. A peristaltic pump 468 is used to provide for two-way flow, such that the deionized water 460 or subsample from vessel 458 can be selective driven into/removed from a reaction vessel 471. The reaction vessel is depicted as coupled to a heating element 473 with a 130° F. temperature set, and to a source 477 of 1M nitric acid (NHO3) for purposes of selective digesting of particulate lead (e.g., for purposes of selecting whether total lead or soluble lead only is to be measured). Another three-way valve 474 provides for selection between the source 477 of nitric acid and an adjuster solution 478 of sodium hydroxide (KOH, ammonia, etc.), provided for purposes of adjusting pH, with a diaphragm pump 475 being used to drive the selected acid/base into reaction vessel 471. Once the subsample has been prepared, as appropriate, it is provided to the voltametric measurement device 453. Note that the voltametric measurement device typically comprises a measurement cell, multiple electrodes and associated measurement electronics, automated selection of suitable reagents and/or buffers, and one or more cleaning agents (as described in the incorporated by reference documents). For example, it is contemplated that voltametric device 453 will include vessels which supply as consumables a copper standard 482 and a lead standard 483 (for purposes of performing spike tests to assess lead/copper concentration), a suitable buffer for copper 484 and a suitable buffer for lead 485 (to provide selection chemistry that causes the voltametric device 453 to measure a selected one of these metals), and one or more buffers and/or cleaning agents 486 for purposes of automated renewal of the measurement cell, to provide for calendared, repeated and/or automated measurements without direct involvement of a human operator. As an example, the various buffers, reagents and/or standards used by such a system, specifically to test lead and copper concentrations can include: (a) for lead, buffer acetate (pH 4.5), 0.2 mM cupferron, and a 500 ppb lead standard; and (b) for copper, 0.2M potassium thiocyanate 0.2M and a 500 ppb copper standard; and (c) for optional mineralization of each substance (as described further below), 1.0M nitric acid and 1.0M ammonium hydroxide. Naturally, other combinations of materials and other chemistries may be used, as deemed appropriate by those having skill in the art in view of the materials, fluids and/or metals being monitored/tested. Note that the configuration 451 of FIG. 4C does not include an optional filter such as discussed relative to the previous FIG., though it is of course possible to adjust the design represented by FIG. 4C so as to add this element.

FIG. 4D is a flow diagram illustrating a series of measurement steps 491 that can be used for one implementation of a lead/copper monitor for an aqueous matrix. A control system 492, or set of control electronics (comprising circuitry, such as one or more processors, and/or instructional logic) controls the various pumps, valves and selectors of a system to perform a series of measurement tasks in a desired sequence. In this case, as depicted in FIG. 4D, a sample/subsample can first be optionally processed to destroy organics, per numeral 493. For example, if the measurement system includes a UV exposure system (e.g., a UV lamp positioned in close proximity to a capillary through which a sample/subsample is passed), the same can be processed to destroy these organics (which could potentially create measurement noise and impact measurement resolution). Such processing might be particularly desirable for situations where a fluid under analysis is water or coolant (e.g., or another liquid), although it can typically be omitted for potable water obtained from a reliable source of “clean” water (e.g., many municipal water companies). In a first measurement cycle, a sample/subsample is processed to measure soluble lead, per numeral 494, optionally filtering the sample/subsample in advance to remove lead particulate. As indicated by numeral 495, as part of this measurement cycle (and typically, each of ensuing measurement cycles 497 and 498), a sample/subsample is adjusted for suitable chemistry (e.g., pH), and a buffer solution is added to “select” a particular substance, e.g., metal specie, for which concentration is to be measured; subsequently, a spike test is performed in which a standard having a predetermined concentration of the metal being measured is added to the sample/solution, and the impact of this addition on measured voltammetry is taken into account to identify concentration of the metal originally present in the sample/subsample prior to addition of the standard. Per numeral 496, other species of the metal being measured can be digested (e.g., converted to a form or species specifically measured by selection chemistry of the voltametric system, with differential concentration measurements being effectuated to determine total metal and metal speciation). As needed between measurement iterations, the sample/subsample is drained from the measurement cell, and the measurement cell and any associated electrodes are renewed, e.g., through introduction of suitable cleaning agents and shedding and/or recycling of a mercury droplet/liquid mercury electrode (as described in the incorporated by reference documents). Finally, per numeral 498, a subsample is drawn to measure copper concentration in similar fashion, and the process is then looped back for subsequent processing of a new sample, per numeral 499.

FIGS. 4B-4D represent a design where a system includes one or more test carriers, and is used to measure metal corrosion under different water input conditions. It should be understood that the use of such a system is not required for all embodiments. For example, as described earlier, it is possible to use actual elements of a distribution or recirculation system for a fluid, used for example, to distribute water to customers or in a manner still in active service for fluid recirculation, for purposes of measuring degeneration/corrosion. Thus, one embodiment uses dedicated “test carriers” and/or coupons to measure metal corrosion and/or scale degradation, while another different embodiment dispenses with these dedicated test carriers and instead measures degradation/corrosion in a specific distribution/recirculation network. These embodiments optionally use correlation of measured metrics for a fluid as water or coolant, e.g., flow rate, pH and other mentioned metrics, to develop a predictive model that can be used to understand expected or worst case degradation/corrosion in a distribution/recirculation network given future conditions. Yet another embodiment relies on previously compiled data (optionally obtained using one of these systems). This other embodiment relies on a previously-developed predictive model and receives dynamically measured metrics as an input, which are then used to predict degradation/corrosion and take optional mitigation. Yet another embodiment relies on a measurement network to dynamically react to instantaneous measured metal corrosion and/or develop an enhanced predictive model, based on feedback and/or measured metrics, to learn and/or manage a distribution/recirculation network. One having rudimentary skill in the art will understand that the various individual components and elements descried above are optional depending on purpose, implementation and context, e.g., the use of dedicated test carriers are optional in an embodiment which simply measures/reacts to the presence of metal concentration measured at point of customer delivery.

### IV. EXEMPLARY TEST PROCESSES

A determination of scale thickness and/or how scale thickness (or scale constituency) locally varies as a function of the specific network/network element and/or fluid enables dynamic feedback and use of control processes to tailor scale constituency; for example, by identifying how scale forms on a given pipe material of a given age as a function of pH, ORP, surface roughness, surface area-to-volume, temperature, alkalinity and/or other factors, one can identify how to control scale formation so as to urge scale to develop on a pipe surface if scale is too thin (e.g., if unacceptable trace concentrations of a corroded material are found in the fluid being distributed/recirculated), and conversely to reduce the tendency to build scale if scale health is determined to be adequate. As noted previously, controls can be achieved in one embodiment by adjusting factors correlated with scale growth or reduction, for example, pH, ORP, surface roughness, surface area-to-volume, temperature, presence or absence of carbonate, bicarbonate, zinc, calcium, alkalinity levels or other factors. Note again that not all scales are desired and in some embodiments, growth of specific types of scale may be preferred over others, i.e., it may be desired to promote the growth of phosphate-based scales which combine with metal from the network component of interest while inhibiting the growth of other scales (e.g., metal oxide forms, which may be temperature dependent or more variable, as well as disfavored scale forms such as limescale). In one contemplated embodiment, as noted earlier, small amounts of phosphates (e.g., polyphosphate) or other additives can be proactively added so as to promote growth of the desired scale type relative to other scale types, and to maintain a minimum layer thickness of the desired scale type (represented by thickness-value th₀). In still another embodiment, thicknesses can be regulated between upper and lower values (e.g., represented by minimum thickness-value thₘᵢₙ and by maximum thickness-value thₘₐₓ). It is also possible to have rules that govern when and how mitigation is performed, e.g., adding phosphates to a water distribution system at times when that system is primarily used for irrigation, in advance of low flow conditions, and so on, as might be desired for a given implementation.

Corrosion for many metal types can be a complex process and, to this end, processing techniques can advantageously be adapted to a specific metal type and/or types at-issue. FIGS. 5A and 5B for example are used to illustrate some of the complexities associated with management of lead in water. Lead corrosion is a complex process that can be affected by multiple environmental parameters and anticorrosion treatment (if any is implemented). As seen from FIG. 5A, metal lead can react with and produce insoluble scale with carbonates (e.g., CO₃ as well as bicarbonate, (CO₃)₂, phosphates (e.g., PO₄) and oxides, each of which can form protective layer on the pipe. Carbonates are often normally naturally present in water, to varying degrees, while phosphates typically are not present and must be artificially added. Lead phosphate solids are typically harder and less soluble than lead carbonate solids at most environmentally-relevant conditions, and therefore present an advantage in terms of acting as a protective scale. Lead carbonates may be either soluble or insoluble, depending on specific water conditions (see FIG. 5B, which shows different forms of lead that can be found in water, as well as different types of lead-based scale). As noted in these FIG. 5B, meatal lead can form insoluble PbO2 (lead dioxide) as a product of oxidation of lead-2 [Pb(II)] by oxygen or chlorine. Depending on water composition and relevant environmental parameters (e.g., pH, ORP, temperature, phosphate concentration/dosing, etc.). pertinent scale forms can be emphasized and/or selected by managing dissolved di-valent lead ions according to reactions below:

Pb₃(CO₃)₂(OH)₂(s)+2H+=3Pb²⁺+2CO₃²⁻+2H₂O; (1)

Pb₅(PO₄)₃OH(s)+H⁺=5Pb²⁺+3PO₄³⁻+H₂O; and (2)

2H⁺+PbO₂(s)=Pb²⁺+½O₂(aq)+H₂O.

FIG. 5B shows the dominant lead solid phase or dissolved species as a function pH and oxidation-reduction potential for (a) 30 mg/L dissolved inorganic carbon (DIC) and (b) 3 mg C/L DIC plus 3 mg/L dissolved orthophosphate The diagrams are constructed for a total lead concentration of 15 μg/L.

The voltametric techniques discussed above can be applied to measure dissolved ionic lead (Pb(II)). In order to measure colloidal or particulate lead (see reactions (1)-(3), above) these species are mineralized as further described in the incorporated by reference documents. Insoluble lead salts or oxides are dissolved as part of the mineralization process to cause the liberation of ionic lead. Then, ionic lead is measured as a “total” (aggregate) species form measurement without specifying its original precursor. To achieve this, one can optionally use following mineralization strategies: acidification (e.g., using nitric, hydrochloric or other acids, or combinations of thee various acids), heating, ultraviolet (UV) light exposure and/or ultrasound (US) application. Low pH generally causes decomposition of scale, while temperature accelerates the process and ultrasound helps break down particulate. In one specific implementation, a process can use nitric acid having a pH of 1.0 and contemporaneous heating (to a range of 60-90° C.) to break down colloidal particulates. As described in the incorporated-by-reference documents, UV irradiation is an effective option for situations where organics are present in the fluid of interest to an extent that affects measurement accuracy.

The described techniques can be extended on a straightforward basis to metal copper. In potable water for example, as with lead, copper may present in dissolved, colloidal and precipitated forms. Voltammetry can be used to measure concentrations of cupric ion (Cu(II)) with mineralization and repeat measurement used to convert total copper to this form and to provide copper species differentiation. The sample pretreatment mechanisms described above for lead mineralization are expected to work equally well for copper species.

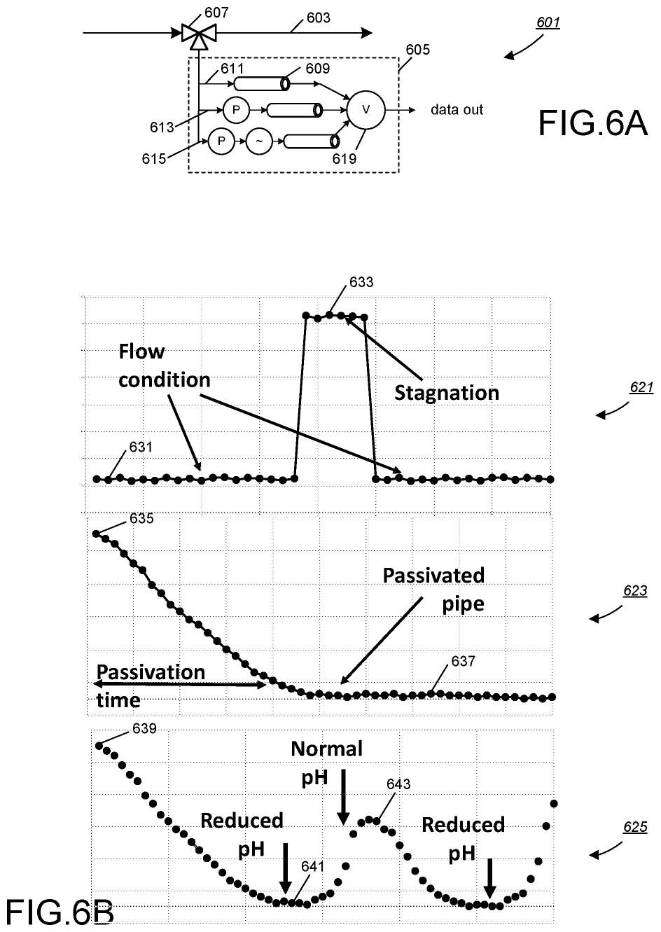

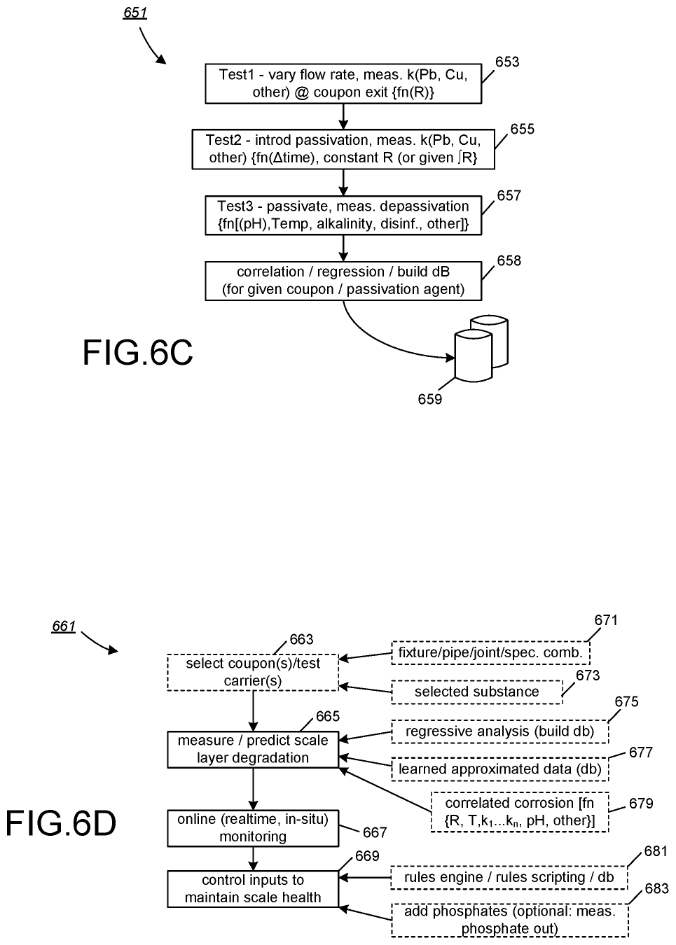

FIG. 6A provides a block diagram showing another possible implementation 601 of a specialized test apparatus 605 that can optionally be used in conjunction with fluid distribution and/or recirculatory systems. The test apparatus 605 in this example is a self-contained apparatus that is plugged into a distribution/recirculatory network 603 at point 607 and serves to take samples so as to build a database (i.e., learn parameters) specific to the network 603 (or an element or subset thereof, e.g., a section of pipe, a joint, a fixture, and so forth), e.g., much as was described above in connection with FIG. 4B. Data produced by such a test apparatus is represented in the FIG. by a legend “data out” (this data can be stored locally, can be relayed via a local area network or “LAN” to a local network destination such as a server, or can be relayed via a wide area network or “WAN” to a remote destination, for example, associated with a water company headquarters, a data center, or a third party that provides monitoring as a service, e.g., a for-fee service). The system 605 in this embodiment features use of a “coupon” 609, which in this specific case is optionally actual part of the network/distribution system which has been cut therefrom, or which is otherwise selected to mimic behavior of the network or network element of interest. For example, in one contemplated application, the test apparatus 605 is designed to receive a section of pipe (or pipes) as a modular element (e.g., a section of aged lead or copper pipe cut from a distribution/recirculatory system of interest); the length of pipe need not be extensive if it is reasonably representative of the network or network element of interest (e.g., a section a few inches long typically will suffice). In another contemplated embodiment, the coupon can be pre-selected or provided with a distributed system so as to model conventional network materials of interest (e.g., such that a section of the actual network being modeled does not have to be removed)—for example, a system can be pre-fitted with a conventionally common source of lead, copper or another material (e.g., metal) by a pipe-supplier, such that it is intended to model a specific material type of interest distributed by that supplier. Note, however, that for many embodiments, it might be preferred to use an actual sample excised from a network or network element that is of interest, i.e., so as to accurately model materials, age, surface roughness, pipe diameter and other parameters specific to the network or component being measured; for this reason, some embodiments of the test apparatus 605 are advantageously configured to permit modular connection to a standard size (e.g., 5-inch) section of material removed by an end customer and fitted to the test apparatus 605. This level of specificity/customization can provide results that are tailored to a specific network having difficult to replicate/model decay parameters. At the same time, as represented by the bleeding of samples from the network of interest (at point 607), the combination of exactly the same fluid that travels through the network at any point in time, and the same pipe (or fitting, or other network element that this fluid is traveling through) advantageously fosters results closely tailored specifically to the network and/or component being modelled.

In one contemplated configuration, the test apparatus intermittently performs three types of tests for a given network element and given distribution/recirculating fluid, conceptually represented in the FIG. by sample paths 611, 613 and 615; it should be appreciated that these flow paths are illustrative, and that a test apparatus with various control values and e.g., a rotary selector, can be used to perform all tests with a single sample extraction mechanism and measurement system, or that a greater or lesser number of paths and/or sample processes can be used in other embodiments. First, fluid can be sampled and tested with no controls (e.g., at an entrance and/or exit point to the coupon 609, prior to passing through the coupon), as represented by path 611, with a voltametric measurement system 619 once again being advantageously used to detect precise metal concentrations, with optional metal species discrimination. Second, the fluid as affected by the coupon 609 with passivation controls (P) can be tested, as represented by sample path 613, with differential results optionally being obtained, e.g., from comparison with the samples 611. Third, testing can be performed with concurrent variation of various influencing parameters (represented by the variable control symbol “˜”) (i.e., either individually or in various permutations and combinations) to readily generate data that shows the influence of control of those inputs; for example, by varying pH (e.g., through the addition of additives or reagents by sample injection at the test apparatus 605), temperature or other factors, and combinations of those factors, following establishment of a steady-state level of passivation, one can identify how passivation is undone, i.e., how a scale layer breaks down for the particular network and/or element of interest.

FIG. 6B is a chart with a series of three graphs, 621, 623 and 625 that illustrate these various tests and expected data. Note that the depicted protocol permits measurement of scale, and effective corrosion control, at a single measurement point (e.g., using a single device with a “coupon” as described above), though the depicted process is naturally not restricted to such a test apparatus or to the specific configuration and/or order of the depicted tests.

The first graph 621 corresponds to the first sample path/protocol 611 from FIG. 6A, i.e., a coupon—or a section of pipe or part or all of a network of interest—is measured as a function of flow rate (R), with an “x-axis” of the graph corresponding to time and a “y-axis” corresponding to presence of trace amounts of a corroded metal, such as lead, copper, chromium, etc. As depicted in region 631, when flow rate are high, detected metal is generally less, whereas when flow rate stagnates (e.g., in region 633), metal concentration increases. A voltametric measurement system is controlled in a series of automated cycles to draw a fluid sample and in real-time detect differences in these concentrations (e.g., to determine concentration of aggregate metal of a specific type or a specific metal species of interest) and to renew sampling mechanisms and draw new samples as needed (i.e., as flow rate is varied). Note that such a process also advantageously implements a “spike test” that permits the system to discriminate metal presence natively in fluid supply from metal that leaches from the network itself (i.e., from the coupon, in a coupon-based system). A control system for the voltametric measurement system scripts sampling intervals so as to obtain a set of measurements that permit forecasting of rate of metal corrosion, absent passivation efforts, for the fluid of interest (e.g., at any particular point in time).

The second graph 623 represents initiation of passivation efforts (e.g., from a time when corrective chemical additives are introduced) and are used to assess effectiveness of passivation efforts; note that in contemplated variations, passivation can applied on a basis that is Boolean (that is, for example, additives either are or are not introduced) or on a basis where concentration and degree of passivation is varied (that is, so as to develop a correlation between amount of passivation applied and degree of success). Note that flow rate is preferably kept constant during the second set of tests (i.e., corresponding to sample path 613 from FIG. 6A), but this is not required for all embodiments. A first region 635 of the graph 623 represents an initial period where passivation is not yet effective, whereas a second region 637 represents a steady-state condition, e.g., corresponding to a condition where a minimum (or threshold or steady-state) scale thickness is achieved. For example, in one contemplated implementation, passivation can be embodied in the form of adding a fixed concentration of polyphosphates, within safe and regulatory limits, and inferring growth of minimum phosphate-based scale thickness at a time where corrosion drops to zero (i.e., trace metal presence adopts a steady state condition which is “close to” that observed at a maximum flow rate condition (i.e., region 633 from graph 621). Graph 623 represents “learning,” given a particular fluid of interest (e.g., specific potable water supply branch or line) and given a specific coupon (or network segment) of interest, of a curve associated with effectiveness and time delay until effectiveness associated with specific passivation efforts.

The third graph 625 corresponds to sample path 615 from FIG. 6A, i.e., where an initial region 639 represents initiation of passivation (i.e., just as was the case for the second depicted graph 623) but, where, after a steady state is reached (e.g., at region 641), specific control variables are varied, for example, pH, temperature (T), total alkalinity, and other factors. For example, the third graph 625 exemplifies a situation where, once steady-state passivation is achieved, pH is then raised (e.g., via addition of a basic standard) which causes inferred degeneration of the scale layer (i.e., corresponding to region 643). While exemplified for pH specifically, it should be understood that the third graph exemplifies tests which are specific to individual environmental parameters (or specific combinations of environmental parameters), where a goal of such tests are to independently assess impact of one or more environmental parameters in degrading a scale layer (and thus, enhancing corrosion/leaching).

FIG. 6C provides a flow chart (generally designated using numeral 651) that represents these three categories of test processes, 653, 655 and 657, and associated correlation/regression methods 658, that will be used to build a database (659) of control information that can be used to manage a particular network of interest.

It should again be noted that performing a sequence of related tests, to measure scale formation and then to measure how environmental parameters affect degradation, and by measuring degradation as a function of trace metal presence, permits a system, optionally founded on a test apparatus and optional coupon customization, as described above, to efficiently learn corrosion parameters for nearly any system of interest. That is, by employing the referenced techniques with a suitable database and corrosion control management software 659, optionally customized/tailored for a specific network of interest, one may learn tendencies of a specific network to suppress or foster corrosive conditions as a function of network operation and relevant environmental parameters.

FIG. 6D shows a block diagram 661 illustrating one embodiment of set of optional techniques for monitoring for corrosion and/or proper scale health. As indicated by optional element 663, in some implementations, a customer or other entity “selects” one or more coupons (or other test carriers) that will be used to model a distribution/circulatory network or a specific element therein. As noted earlier, in some embodiments, a test apparatus and/or voltametric measurement device is fitted with mechanisms that permit selective connection to a selected material (e.g., section of a selected pipe or joint) and for in-line connection to a particular distribution and/or recirculatory network of interest so as to assess potentially a myriad of different environmental parameters. As an example, if it is assumed that a test system is installed in a rural community supported by well-water, it might well be that aquifer conditions vary seasonally; by using the same water as is distributed (in such a system), a test apparatus, measurement system and/or control system is better able to predict corrosion trends and take preventive and/or remedial action, founded on data correlated in the past with proper scale health for the particular network of interest. As denoted by numeral 665, measurements are used to measure and/or predict scale layer parameters, based on online (i.e., real-time, in-situ) monitoring 667; per numeral 669, control inputs, previously correlated with scale health, can be used to increase scale of a particular type or thickness and maintain scale health or, conversely, take mitigation actions when changing conditions foster a prediction that scale health will be degraded. Again, these actions can be optionally rooted in past learned data, for example, produced from the use of a test apparatus and/or methods as were described above.

Numerals 671-683 show a series of options associated with the methodology 661 of FIG. 6D. For example, a coupon or test carrier (or a database used for control, or a “built-in” device used to model performance of a given system) can be structured so as to model a specific fixture/pipe/joint, or any combination thereof. Per numeral 673, such a coupon (or test carrier, or precompiled data) can be configured to model a specific substance of interest, for example, and without limitation, lead, copper, chromium, selenium and so forth. In one embodiment, as data is collected, processing software (not seen in the FIG.) performs regressive or other mathematical analysis to build a database of control weights that will be used to take actions based on measured parameters or characteristics, for example, flow rate (R), temperature (T), pH, alkalinity, presence of disinfection agents, presence of silica, carbonate, and/or concentrations of other substances (such as organics or specific metals), per numeral 679. As indicated by numeral 675, as data is collected, a database can be built which models a specific type of material or network or network element; this permits the “learning” of parameters specific to any given network and any given fluid transferred through or carried by that network, per numeral 677. Without limitation, software can implement a rules engine 681 that takes actions as needed to mitigate actual or predicted conditions, or to suit desired performance for a specific network. While such an example is by no means limiting, it is possible for example to add phosphates (or other scale building substances, per numeral 683) as defined by rules, e.g., during night hours, or when a multi-purpose distribution system is expected to carry water for non-potable applications (e.g., irrigation), or during specified flow conditions, thereby facilitating a situation where phosphates can both help build scale and excess phosphates can be safely discarded (e.g., synergistically applied for fertilization). It is also possible to add a measurement device at a system output (e.g., customer delivery point in the case of water distribution) so as to test for the presence of excess mitigation agents (e.g., phosphates), and use feedback to adjust delivery parameters to achieve safe levels, as indicated by numeral 684

### V. FINAL CONSIDERATIONS

While description of embodiments described above has tended to focus on potable and non-potable water and coolant as being a primary applications, it is contemplated that the systems, networks and techniques described above can be applied to other types of aqueous matrices, whether water or otherwise. Indeed, the described techniques can be applied to any type of liquid in which effects of corrosion may be present. As implied, it is also contemplated that these systems, networks and techniques can be applied to other types of fluids, including without limitation, corrosive gasses, and their associated distribution/recirculation networks. The described techniques can be embodied at many different tiers of manufacture/implementation, including without limitation: (a) design and/or sale of software for performing/controlling tasks discussed herein, e.g., as instructions stored on nontransitory media; (b) an apparatus, system or device configured to measure corrosion and/or degradation of one or more test carriers, optionally supplied separately; (c) installation and/or use of a network or related techniques which react to detected degradation/corrosion, or which use feedback to develop and/or refine a predictive model; and/or (d) results of using any of the foregoing.

It should be appreciated that by providing techniques which address measuring network degradation and/or corrosion, the present disclosure significantly enhances ability to control/manage substances which can present a danger to human health or cause further degradation to a network used to distribute and/or recirculate fluids. These techniques provide tools that can be used by water suppliers and others to better understand how their choices and seasonal effects cause variation in harmful substances, including toxic metals and carcinogens, in water, optionally in specific networks of interest, and to take proactive measures that will ensure proper scale health, avoid corrosion and/or mitigate the presence of these materials in water.

The foregoing description and in the accompanying drawings, specific terminology and drawing symbols have been set forth to provide a thorough understanding of the disclosed embodiments. In some instances, the terminology and symbols may imply specific details that are not required to practice those embodiments. The terms “exemplary” and “embodiment” are used to express an example, not a preference or requirement.

Various modifications and changes may be made to the embodiments presented herein without departing from the broader spirit and scope of the disclosure. Features or aspects of any of the embodiments may be applied, at least where practicable, in combination with any other of the embodiments or in place of counterpart features or aspects thereof. Accordingly, the features of the various embodiments are not intended to be exclusive relative to one another, and the specification and drawings are to be regarded in an illustrative rather than a restrictive sense.

1. A method of generating data to predict corrosion of a metal material from an element of a network that carries a fluid, where the corrosion results in transfer of metal from the metal material to the fluid, the method comprising:
receiving data representing at least one environmental parameter which characterizes the fluid, the at least environmental parameter comprising at least one of pH of the fluid, alkalinity of the fluid, and temperature of the fluid;
in association with the data,
with a sampling mechanism, drawing a sample from the fluid that has been exposed to the metal material, and
with a measurement device, detecting a concentration of the metal in the sample; and
with at least one processor,
correlating change in value of the at least environmental parameter with change in detected concentration of the metal corresponding to the corrosion, and
storing data in non-transitory storage representing the correlation.

2. The method of claim 1, wherein the measurement device comprises a voltametric device and wherein the metal comprises at least one of lead and copper.

3. The method of claim 1, wherein the method further comprises:
intermittently measuring the at least one environmental parameter characterizing the fluid, to detect change thereto;
dependent on the data stored in the non-transitory storage, detecting a trend correlated with increase in a level of the corrosion; and
upon detection of the trend, causing a processor to take a reaction comprising at least one of generating data to be presented to an operator which conveys the trend, and initiating an automated adjustment of the fluid in the network so as to correct the trend.

4. The method of claim 1, wherein the element of the network comprises at least one of a pipe, a vessel, a junction and a fixture, and wherein:
the method further comprises excising a portion of the element from the network and coupling the excised portion of the element to a test apparatus; and
drawing the sample comprises passing the sample of the fluid through the excised portion of the element, to thereby expose the sample to the metal material.

5. The method of claim 4, wherein:
the method further comprises deliberately changing a given environmental parameter of the at least one environmental parameter and, in association therewith, repeating the drawing a sample and the detecting a concentration of the metal for different values of the given environmental parameter; and
correlating comprises identifying a weight associated with influence of different values of the given environmental parameter upon transfer of the metal from the metal material to the fluid.

6. The method of claim 5, wherein the given environmental parameter is a first environmental parameter of the at least one environmental parameter and the weight is a first weight, and wherein:
the method further comprises deliberately changing a second environmental parameter of the at least one environmental parameter and, in association therewith, repeating the drawing a sample and the detecting a concentration of the metal for different values of the second environmental parameter; and
correlating comprises identifying a second weight associated with influence of different values of the second environmental parameter upon transfer of the metal from the metal material to the fluid, and associating a time lag with one of the first environmental parameter and the second environmental parameter that is free to be different than a time lag for the other of the first environmental parameter and the second environmental parameter.

7. The method of claim 5, wherein the method further comprises establishing a steady state scale condition, and wherein receiving the data comprises, after the stead state scale condition is established, deliberately varying a given environmental parameter of the at least one environmental parameter, the data representing change in the value of the given environmental parameter.

8. The method of claim 4, wherein the method further comprises correlating a value characterizing a layer of scale with detected concentration of the metal in the sample.

9. The method of claim 8, wherein the metal is lead, wherein the layer of scale comprises at least one of lead-oxide and lead-carbonate, and wherein the method further comprises causing at least one processor to format a display image that is to visually display information dependent on the value characterizing the layer of scale to a human.

10. The method of claim 1, wherein the given environmental parameter is a first environmental parameter of the at least one environmental parameter and the weight is a first weight, and wherein:
the method further comprises deliberately changing a second environmental parameter of the at least one environmental parameter, and repeating the drawing a sample, the detecting a concentration of the metal for different values of the second environmental parameter; and
correlating comprises identifying a second weight associated with influence of different values of the second environmental parameter upon transfer of the metal from the metal material to the fluid, and associating a time lag with one of the first environmental parameter and the second environmental parameter that is free to be different than a time lag for the other of the first environmental parameter and the second environmental parameter.

11. The method of claim 1, wherein the method further comprises establishing a steady state scale condition, and wherein receiving the data comprises, after the stead state scale condition is established, deliberately varying a given environmental parameter of the at least one environmental parameter, the data representing change in the value of the given environmental parameter.

12. The method of claim 1, wherein the method further comprises correlating a value characterizing a layer of scale with detected concentration of the metal in the sample.

13. The method of claim 12, wherein the metal is lead, wherein the layer of scale comprises at least one of lead-oxide and lead-carbonate, and wherein the method further comprises causing at least one processor to format a display image that is to visually display information dependent on the value characterizing the layer of scale to a human.

14. The method of claim 1, wherein the method further comprises associating the data with at least one of (a) a value dependent on a surface area of the element which is to interact with the fluid with a volume of the fluid which passes the surface area, and (b) a value dependent on a surface roughness of the element for a surface which is to interact with the fluid.

15. A test apparatus to generate data to predict, in network that carries a fluid, corrosion of a metal material from an element of the network, where the corrosion results in transfer of metal from the metal material to the fluid, the test apparatus comprising:
an interface to receive a test carrier representing the element of the network and having the metal material;
a mechanism to draw samples of the fluid and to expose the samples of the fluid to the test carrier;
a measurement device to detect a concentration of the metal in the samples of the fluid which has been exposed to the test carrier; and
at least one processor to
receive data representing at least one environmental parameter which characterizes the fluid, the at least environmental parameter comprising at least one of pH of the fluid, alkalinity of the fluid, and temperature of the fluid,
correlate change in value of the at least environmental parameter with change in detected concentration of the metal, and
store data in non-transitory storage representing the correlation.

16. The test apparatus of claim 15, wherein the test carrier comprises at least one of a segment or a portion of a vessel from the element of the network, and wherein interface comprises at least one modular connection to couple the test apparatus to the test carrier so as to provide the samples of the fluid thereto and remove the samples of the fluid therefrom following exposure to the test carrier.

17. The test apparatus of claim 15, wherein the measurement device comprises a voltametric device having a liquid mercury electrode, a trap to collect spent mercury, and a pump to renew the mercury electrode from the spent mercury.

18. The test apparatus of claim 15, wherein the metal comprises at least one of lead or copper and wherein the measurement device comprises a voltametric system adapted to measure concentration of the at least one of soluble lead or soluble copper.

19-26. (canceled)
